(19) United States
(12) Patent Application Publication
(10) Pub. No.: US 2018/0268792 A1
(43) Pub. Date: Sep. 20, 2018

(54) SYSTEM AND METHOD FOR AUTOMATICALLY GENERATING MUSICAL OUTPUT

(71) Applicant: ZYA, INC., Calabasas, CA (US)

(72) Inventors: Matthew Michael Serletic, Calabasas, CA (US); Bo Bazylevsky, Calabasas, CA (US); James Mitchell, Calabasas, CA (US); Ricky Kovac, Calabasas, CA (US); Patrick Woodward, Calabasas, CA (US); Thomas Webb, Calabasas, CA (US); Ryan Groves, Montreal, CA (US); Ed Schofield, Calabasas, CA (US); Brett Harrison, Calabasas, CA (US)

(21) Appl. No.: 15/986,589

(22) Filed: May 22, 2018

Related U.S. Application Data
(63) Continuation-in-part of application No. 15/431,521, filed on Feb. 13, 2017.
Application No. 15/431,521 is a continuation of application No. 14/834,187, filed on Aug. 24, 2015, now Pat. No. 9,570,055.
(60) Provisional application No. 62/509,727, filed on May 22, 2017.
(60) Provisional application No. 62/524,838, filed on Jun. 26, 2017.
(60) Provisional application No. 62/121,803, filed on Feb. 27, 2015.
(60) Provisional application No. 62/040,842, filed on Aug. 22, 2014.

(51) Int. Cl. G10H 1/00; G10L 25/48; H04N 9/87; H04N 9/802; G10L 13/027

(52) U.S. Cl. CPC G10H 1/0025; G10L 25/48; G10H 2250/455; G10H 2240/131; G10H 2240/085; G10H 2220/106; H04N 9/8715; G10H 2210/111; H04N 9/802; G10L 13/027

(57) ABSTRACT

A computer implemented method for automatically generating musical works including receiving a lyrical input and receiving a musical input. The method includes analyzing the lyrical input to determine at least one lyrical characteristic and analyzing the musical input to determine at least one musical characteristic. Based on the at least one lyrical characteristic, the method includes correlating the lyrical input with the musical input to generate a synthesizer input. The method includes sending the synthesizer input and the at least one voice characteristic to a voice synthesizer. The method may also include receiving, from the voice synthesizer, a vocal rendering of the lyrical input. The method includes receiving a singer selection corresponding to at least one voice characteristic, and generating a musical work from the vocal rendering based on the lyrical input, the musical input, and the at least one voice characteristic.

### CROSS-REFERENCE TO RELATED APPLICATIONS

This application claims priority to U.S. Provisional Application No. 62/509,727, filed May 22, 2017, and U.S. Provisional Application No. 62/524,838, filed Jun. 26, 2017. This application is also a continuation-in-part of U.S. patent application Ser. No. 15/431,521, filed Feb. 13, 2017, which is a continuation of U.S. patent application Ser. No. 14/834,187, filed Aug. 24, 2015, now U.S. Pat. No. 9,570,055, which claims priority to U.S. Provisional Application No. 62/121,803, filed Feb. 27, 2015, and U.S. Provisional Application No. 62/040,842, filed Aug. 22, 2014. The disclosures of the aforementioned documents are incorporated by reference herein.

### TECHNICAL FIELD

The present disclosure relates generally to the field of music creation, and more specifically to a system of converting text to a musical composition.

### BACKGROUND

Currently, songwriters and other music creators do not have a tool that allows easy vocal track creation. Typically songwriters have to go through the laborious and expensive process to, among other things, write lyrics, write a vocal melody that fits the lyrics, hire a singer, rent a recording studio, hire and audio engineer and/or producer, record the singer, compile the best takes, tune the best performance, create background vocals, and mix the audio with the rest of the track. A solution is needed to allow people to create music more easily and more accessibly, without the time and resources traditionally required.

### SUMMARY

In an embodiment, the disclosure describes a computer implemented method for automatically generating musical works. The computer implemented method may include receiving a lyrical input and receiving a musical input. The method may include analyzing, via one or more processors, the lyrical input to determine at least one lyrical characteristic and analyzing, via the one or more processors, the musical input to determine at least one musical characteristic. Based on the at least one lyrical characteristic, the method may include correlating, via the one or more processors, the lyrical input with the musical input to generate a synthesizer input. The method may include sending the synthesizer input and the at least one voice characteristic to a voice synthesizer. The method may also include receiving, from the voice synthesizer, a vocal rendering of the lyrical input. The method may include receiving a singer selection corresponding to at least one voice characteristic, and generating a musical work from the vocal rendering based on the lyrical input, the musical input, and the at least one voice characteristic.

In another embodiment, the disclosure describes a computer implemented method for automatically generating musical works. The computer implemented method may include receiving a lyrical input and receiving a musical input. The method may include analyzing, via one or more processors, the lyrical input to determine a lyrical characteristic and analyzing, via the one or more processors, the musical input to determine a musical characteristic. The method may also include comparing, via one or more processors, the lyrical characteristic with the musical characteristic to determine a disparity. Based on the determined disparity, the method may include automatically applying, via the one or more processors, at least one editing tool to the lyrical input to generate an altered lyrical input with an altered lyrical characteristic. Based on the altered lyrical characteristic, the method may include correlating, via the one or more processors, the altered lyrical input with the musical input to generate a synthesizer input, and sending the synthesizer input to a voice synthesizer. The method may also include receiving, from the voice synthesizer, a vocal rendering of the altered lyrical input, and generating a musical work from the vocal rendering and the musical input.

In another embodiment, the disclosure describes a computer implemented method for automatically generating musical works. The computer implemented method may include receiving a lyrical input and receiving a musical input. The method may include analyzing, via one or more processors, the lyrical input to determine a lyrical characteristic, and analyzing, via the one or more processors, the musical input to determine a musical characteristic. The method may include comparing, via one or more processors, the lyrical characteristic with the musical characteristic to determine a disparity. Based on the determined disparity, the method may include automatically applying, via the one or more processors, at least one editing tool to the musical input to generate an altered musical input with an altered musical characteristic. Based on the lyrical characteristic, the method may include correlating, via the one or more processors, the lyrical input with the altered musical input to generate a synthesizer input, and sending the synthesizer input to a voice synthesizer. The method may also include receiving, from the voice synthesizer, a vocal rendering of the lyrical input, and generating a musical work from the vocal rendering and the altered musical input.

### BRIEF DESCRIPTION OF THE DRAWINGS

Non-limiting and non-exhaustive embodiments are described in reference to the following drawings. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1 illustrates one exemplary embodiment of a network configuration in which a media generation system may be practiced in accordance with the disclosure;

FIG. 2 illustrates a flow diagram of an embodiment of a method of operating the a media generation system in accordance with the disclosure;

FIG. 3 illustrates an embodiment of a playback slider bar in accordance with the disclosure;

FIG. 4 illustrates a block diagram of a device that supports the systems and processes of the disclosure;

FIG. 5 illustrates a flow diagram of another embodiment of a method of operating the media generation system in accordance with the disclosure;

FIG. 6 illustrates an exemplary graphical user interface for MIDI roll editing in accordance with the disclosure;

FIG. 7 illustrates an exemplary graphical user interface for applying tactile control in accordance with the disclosure;

FIG. 8 illustrates an exemplary graphical user interface for effects adjustment in accordance with the disclosure;

FIG. 9 illustrates a flow diagram of another embodiment of a method of operating the media generation system in accordance with the disclosure;

FIG. 10 illustrates an exemplary graphical user interface in accordance with the disclosure;

FIG. 11 illustrates an exemplary graphical user interface in accordance with the disclosure;

FIG. 12 illustrates an exemplary graphical user interface in accordance with the disclosure;

FIG. 13 illustrates an exemplary graphical user interface in accordance with the disclosure;

FIG. 14 illustrates an exemplary graphical user interface in accordance with the disclosure;

FIG. 15 illustrates an exemplary graphical user interface in accordance with the disclosure;

FIG. 16 illustrates an exemplary graphical user interface in accordance with the disclosure;

FIG. 17 illustrates an exemplary graphical user interface in accordance with the disclosure; and

FIG. 18 illustrates an exemplary graphical user interface in accordance with the disclosure.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

In some embodiments, the disclosure describes a system that may include an audio plugin for use in, for example, digital audio workstations. The system may combine at least a Musical Instrument Digital Interface (MIDI) melody or melodies with a typed or spoken user message to generate a vocal musical performance where the message may become lyrics sung to the MIDI melody. In some embodiments, the system may receive a user or automatically generated selection of a singer or vocalist from a selection of singers and vocalists, receive a melody and a message, and create a performance as if the selected singer or vocalist is singing the message to the tune of the MIDI melody. In some embodiments, the collection of singers or vocalists may include selections from a variety of genres or musical styles, and aspects from those genres and musical styles may be incorporated into the generated vocal track. The message that is the subject of the generated lyrics may be anything ranging from a few words, or to an entire song.

In some embodiments, the system may include additional controls to edit and alter the resultant vocal performance. For example, X/Y axis controls may be used to control aspects of the musical output, such as embellishment or melisma, or slow glide versus auto tune. Additionally, some embodiments of the system may provide various effects that a user may implement manually or that may be implemented automatically, such as reverb, delay, compression, etc.

The present disclosure may also relate to a system and method for automatically generating musical outputs based on various user inputs and/or selections. In some embodiments, the system may include a software plugin that may be used with existing audio and/or visual editing or composition software or hardware. In some embodiments the system may include independent software that may be run on any suitable computing device, such as a smart phone, a desktop computer, a lap top computer, etc. In some embodiments, the device may be part of a network that includes remote servers that conduct all or parts of the musical output generation.

In some embodiments, the system may include an interface, such as a graphical user interface, with which a user may interact in providing and/or selecting a musical input. The musical input may be any of a variety of input types, such as a MIDI input, an audio recording, a prerecorded MIDI file, etc. The system may analyze the musical input, and the musical input may define all or part of the melody or melodies for the generated musical output. The user may also provide a lyrical input using any suitable input device, such as a keyboard, a touchscreen, a control pad, microphone, etc. In some embodiments, the user may provide the lyrical input by speaking and allowing voice recognition to translate the speech into text for the system to use as the lyrical input. The system may then analyze the lyrical input along with the musical input and provide a musical output using the words or sound in the lyrical input as the lyrics of the musical output, the lyrics being sung to the melody of the musical input.

In some embodiments, the user may also select a singer having a voice or style upon which the musical output may be based. The singer's style and/or voice may be modeled by the system in such a way as to provide a musical output of the lyrics in the melody of the musical input as if it were being sung by the selected singer. In some embodiments, the system may include a collection of singers for which models are available. In such embodiments, the user may select the singer via a graphical user interface, or any other suitable selection mechanism, such as voice commands or textual input. The singers may be existing singers or vocalists whose voices and styles have been modeled, or the singers may be fictional characters with voices and styles having been assigned to them. Once the system has received a lyrical input, a musical input, and singer selection, each may be analyzed to produce a musical output sounding like the selected singer singing the words of the lyrical input to the tune of the musical input with the voice and style of the selected singer.

In some embodiments, all or parts of the system and the software included in the system may be implemented in a variety of applications, including via instant messages, via voice command computer interface, such as Amazon Echo, Google Home, or Apple Siri voice command systems, via chat bots, and via filters on third-party or original applications. Features of the system may also be used or integrated into systems to create personal music videos and messages, ringback tones, emojis that sing messages, etc.

In some embodiments, the present disclosure may relate to a system and method for creating a message containing an audible musical and/or video composition that can be transmitted to users via a variety of messaging formats, such as SMS, MMS, and e-mail. It may also be possible to send such musical composition messages via various social media platforms and formats, such as Twitter®, Facebook®, Instagram®, or any other suitable media sharing system. In certain embodiments, the disclosed media generation system provides users with an intuitive and convenient way to automatically create and send original works based on infinitely varied user inputs. For example, the disclosed system can receive lyrical input from a user in the form of a text chain, along with the user's selection of a musical work or melody that is pre-recorded or recorded and provided by the user. Once these inputs are received, the media generation system can analyze and parse both the text chain and the selected musical work to create a vocal rendering of the text chain paired with a version of the musical work to provide a musically-enhanced version of the lyrical input by the user. The output of the media generation system can provide a substantial variety of musical output while maintaining user recognition of the selected musical work. The user can then, if it chooses, share the musical message with others via social media, SMS or MMS messaging, or any other form of file sharing or electronic communication.

In some embodiments, the user can additionally record video to accompany the musically enhanced text. The video can be recorded in real-time along with a vocal rendering of the lyrical input provided by the user in order to effectively match the video to the musical message created by the system. In other embodiments, pre-recorded video can be selected and matched to the musical message. The result of the system, in such embodiments, may be an original lyric video created using merely a client device such as a smartphone or tablet connected to a server via a network, and requiring little or no specialized technical skills or knowledge.

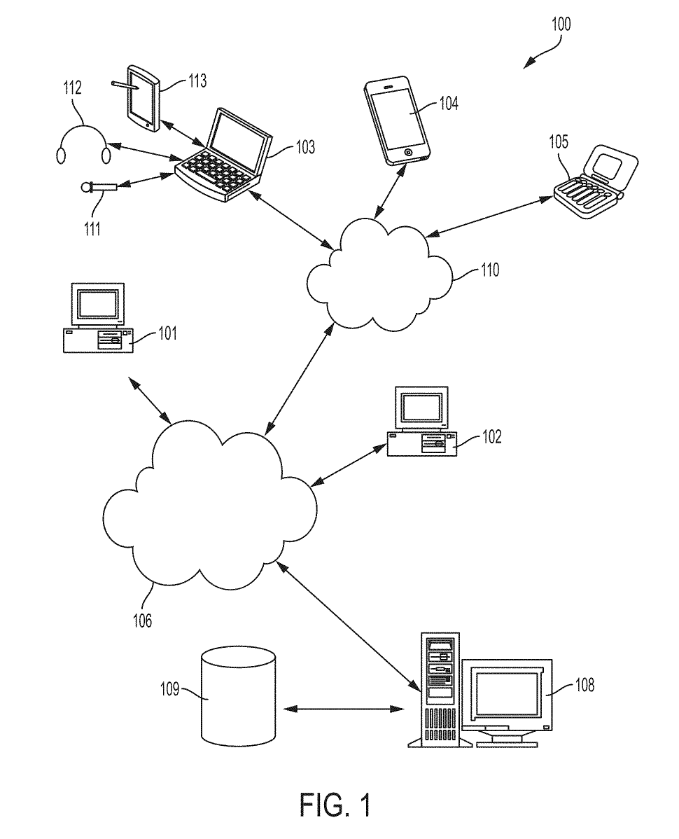

FIG. 1 illustrates an exemplary embodiment of a network configuration in which the disclosed system 100 can be implemented. It is contemplated herein, however, that not all of the illustrated components may be required to implement the system, and that variations in the arrangement and types of components can be made without departing from the spirit of the scope of the invention. Referring to FIG. 1, the illustrated embodiment of the system 100 includes local area networks (“LANs”)/wide area networks (“WANs”) (collectively network 106), wireless network 110, client devices 101-105, server 108, media database 109, and peripheral input/output (I/O) devices 111, 112, and 113. While several examples of client devices are illustrated, it is contemplated herein that client devices 101-105 may include virtually any computing device capable of processing and sending audio, video, textual data, or any other communication over a network, such as network 106, wireless network 110, etc. In some embodiments, one or both of the wireless network 110 and the network 106 can be a digital communications network. Client devices 101-105 may also include devices that are configured to be portable. Thus, client devices 101-105 may include virtually any portable computing device capable of connecting to another computing device and receiving information. Such devices include portable devices, such as cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like.

Client devices 101-105 may also include virtually any computing device capable of communicating over a network to send and receive information, including track information and social networking information, performing audibly generated track search queries, or the like. The set of such devices may include devices that typically connect using a wired or wireless communications medium such as personal computers, multiprocessor systems, microprocessor-based or programmable consumer electronics, network PCs, or the like. In one embodiment, at least some of client devices 101-105 may operate over wired and/or wireless network.

A client device 101-105 can be web-enabled and may include a browser application that is configured to receive and to send web pages, web-based messages, and the like. The browser application may be configured to receive and display graphics, text, multimedia, video, etc., and can employ virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized 25 Markup Language (SMGL), HyperText Markup Language (HTML), eXtensible Markup Language (XML), and the like, to display and send various content. In one embodiment, a user of the client device may employ the browser application to interact with a messaging client, such as a text messaging client, an email client, or the like, to send and/or receive messages.

Client devices 101-105 also may include at least one other client application that is configured to receive content from another computing device. The client application may include a capability to provide and receive multimedia content, such as textual content, graphical content, audio content, video content, etc. The client application may further provide information that identifies itself, including a type, capability, name, and the like. In one embodiment, client devices 101-105 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in, for example, a network packet or other suitable form, sent to server 108, or other computing devices. The media database 109 may be configured to store various media such as musical clips and files, etc., and the information stored in the media database may be accessed by the server 108 or, in other embodiments, accessed directly by other computing device through over the network 106 or wireless network 110.

Client devices 101-105 may further be configured to include a client application that enables the end-user to log into a user account that may be managed by another computing device, such as server 108. Such a user account, for example, may be configured to enable the end-user to participate in one or more social networking activities, such as submit a track or a multi-track recording or video, search for tracks or recordings, download a multimedia track or other recording, and participate in an online music community. However, participation in various networking activities may also be performed without logging into the user account.

Wireless network 110 is configured to couple client devices 103-105 and its components with network 106. Wireless network 110 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like. Wireless network 110 may further include an autonomous system of terminals, gateways, routers, etc., connected by wireless radio links, or other suitable wireless communication protocols. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation, and 4G Long Term Evolution (LTE) radio access for cellular systems, WLAN, Wireless Router (WR) mesh, and other suitable access technologies. Access technologies such as 2G, 3G, 4G, 4G LTE, and future access networks may enable wide area coverage for mobile devices, such as client devices 103-105 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), etc. In essence, wireless network 110 may include virtually any wireless communication mechanism by which information may travel between client devices 103-105 and another computing device, network, and the like.

Network 106 is configured to couple network devices with other computing devices, including, server 108, client devices 101-102, and through wireless network 110 to client devices 103-105. Network 106 is enabled to employ any form of computer readable media for communicating information from one electronic device to another. Also, network 106 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 106 includes any communication method by which information may travel between computing devices.

In certain embodiments, client devices 101-105 may directly communicate, for example, using a peer-to-peer configuration.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

Various peripherals, including I/O devices 111-113 may be attached to client devices 101-105. For example, Multi-touch, pressure pad 113 may receive physical inputs from a user and be distributed as a USB peripheral, although not limited to USB, and other interface protocols may also be used, including but not limited to ZIGBEE, BLUETOOTH, near field communication (NFC), or other suitable connections. Data transported over an external and the interface protocol of pressure pad 113 may include, for example, MIDI formatted data, though data of other formats may be conveyed over this connection as well. A similar pressure pad may alternately be bodily integrated with a client device, such as mobile devices 104 or 105. A headset 112 may be attached to an audio port or other wired or wireless I/O interface of a client device, providing an exemplary arrangement for a user to listen to playback of a composed message, along with other audible outputs of the system. Microphone 111 may be attached to a client device 101-105 via an audio input port or other connection as well. Alternately, or in addition to headset 112 and microphone 111, one or more speakers and/or microphones may be integrated into one or more of the client devices 101-105 or other peripheral devices 111-113. Also, an external device may be connected to pressure pad 113 and/or client devices 101-105 to provide an external source of sound samples, waveforms, signals, or other musical inputs that can be reproduced by external control. Such an external device may be a MIDI device to which a client device 103 and/or pressure pad 113 may route MIDI events or other data in order to trigger the playback of audio from external device. However, it is contemplated that formats other than MIDI may be employed by such an external device.

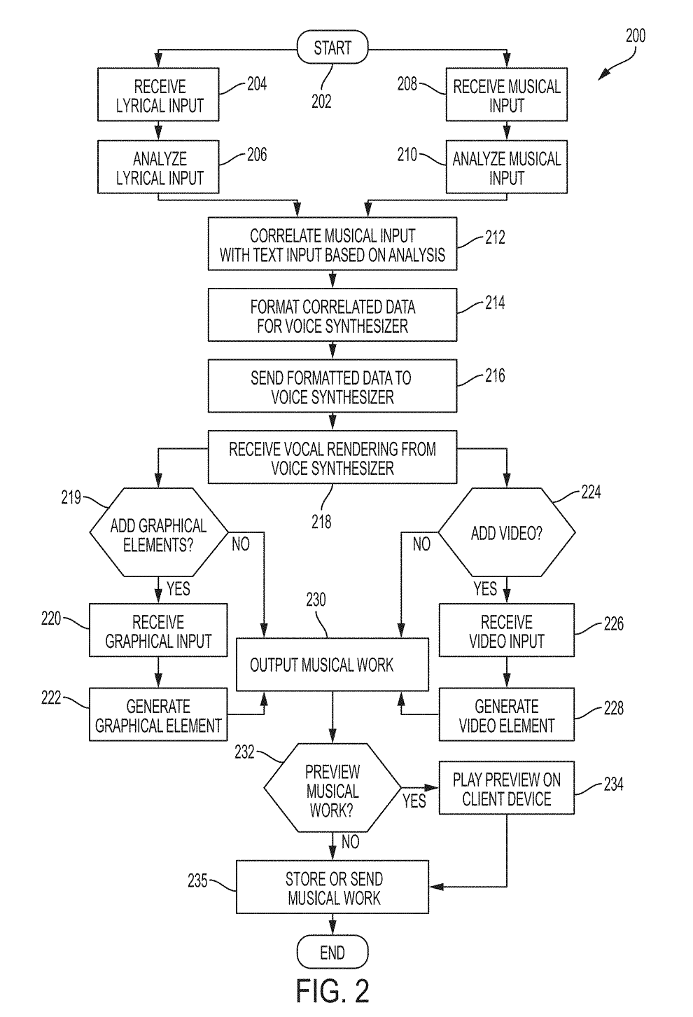

FIG. 2 is a flow diagram illustrating an embodiment of a method 200 for operating the media generation system 100, with references made to the components shown in FIG. 1. Beginning at 202, the system can receive a lyrical input at 204. The text or lyrical input may be input by the user via an electronic device, such as a PC, tablet, or smartphone, any other of the client devices 101-105 described in reference to FIG. 1 or other suitable devices. The text may be input in the usual fashion in any of these devices (e.g., manual input using soft or mechanical keyboards, touch-screen keyboards, speech-to-text conversion). In some embodiments, the text or lyrical input is provided through a specialized user interface application accessed using the client device 101-105. Alternatively, the lyrical input could be delivered via a general application for transmitting text-based messages using the client device 101-105.

The resulting lyrical input may be transmitted over the wireless communications network 110 and/or network 106 to be received by the server 108 at 204. At 206, the system 100 may analyze the lyrical input using server 108 to determine certain characteristics of the lyrical input. In some embodiments, however, it is contemplated that analysis of the lyrical input could alternatively take place on the client device 101-105 itself instead of or in parallel to the server 108. Analysis of the lyrical input can include a variety of data processing techniques and procedures. For example, in some embodiments, the lyrical input is parsed into the speech elements of the text with a speech parser. For instance, in some embodiments, the speech parser may identify important words (e.g., love, anger, crazy), demarcate phrase boundaries (e.g., “I miss you.” “I love you.” “Let's meet.” “That was an awesome concert.”) and/or identify slang terms (e.g., chill, hang). Words considered as important can vary by region or language, and can be updated over time to coincide with the contemporary culture. Similarly, slang terms can vary geographically and temporally such that the media generation system 100 is updatable and customizable. Punctuation or other symbols used in the lyrical input can also be identified and attributed to certain moods or tones that can influence the analytical parsing of the text. For example, an exclamation point could indicate happiness or urgency, while a “sad-face” emoticon could indicate sadness or sorrow. In some embodiments, the words or lyrics conveyed in the lyrical input can also be processed into its component pieces by breaking words down into syllables, and further by breaking the syllables into a series of phonemes. In some embodiments, the phonemes are used to create audio playback of the words or lyrics in the lyrical input. Additional techniques used to analyze the lyrical input are described in greater detail below.

At 208, the system may receive a selection of a musical input transmitted from the client device 101-105. In some embodiments, a user interface may be implemented to select the musical input from a list or library of pre-recorded and catalogued musical works or clips of musical works that may comprise one or more musical phrases. In this context, a musical phrase may be a grouping of musical notes or connected sounds that exhibits a complete musical “thought,” analogous to a linguistic phrase or sentence. To facilitate the user's choice between pre-recorded musical works or phrases, the list of available musical works or phrase may include, for example, a text-based description of the song title, performing artists, genre, and/or mood set by phrase, to name only a few possible pieces of information that could be provided to users via the user interface. Based on the list of available musical works or phrases, the user may then choose the desired musical work or clip for the media generation system to combine with the lyrical input. In one embodiment, there may be twenty or more pre-recorded and selected musical phrases for the user to choose from.

In some embodiments, the pre-recorded musical works or phrases may be stored on the server 108 or media database 109 in any suitable computer readable format, and accessed via the client device 101-105 through the wireless network 106 and/or network 110. Alternatively, in other embodiments, the pre-recorded musical works may be stored directly onto the client device 101-105 or another local memory device, such as a flash drive or other computer memory device. Regardless of the storage location, the list of pre-recorded musical works can be updated over time, removing or adding musical works in order to provide the user with new options and additional choices.

It is also contemplated that individual users may create their own melodies for use in association with the media generation system. One or more melodies may be created using the technology disclosed in U.S. Pat. No. 8,779,268 entitled “System and Method for Producing a More Harmonious Musical Accompaniment Graphical User Interface for a Display Screen System and Method that Ensures Harmonious Musical Accompaniment” assigned to the assignee of the present application. Such patent disclosure is hereby incorporated by reference, in full. In other embodiments, a user may generate a musical input using an input device 111-113, such as a MIDI instrument or other device for inputting user-created musical works or clips. For example, in some embodiments, a user may use MIDI keyboard to generate a musical riff or entire song to be used as the musical input. In some embodiments, a user may create audio recording playing notes with a more traditional, non-MIDI instrument, such as a plano or a guitar. The audio recording may then be analyzed for pitch, tempo, etc., to utilize the audio recording as the musical input.

In further embodiments, individual entries in the list of musical input options are selectable to provide, via the client device 101-105, a pre-recorded musical work (either stored or provided by the user), or a clip thereof, as a preview to the user. In such embodiments, the user interface associated with selecting a musical work includes audio playback capabilities to allow the user to listen to the musical clip in association with their selection of one of the musical works as the musical input. In some embodiments, such playback capability may be associated with a playback slider bar that graphically depicts the progressing playback of the musical work or clip. Whether the user selects the melody from the pre-recorded musical works stored within the system or from one or more melodies created by the user, it is contemplated that the user may be provided with functionality to select the points to begin and end within the musical work to define the musical input.

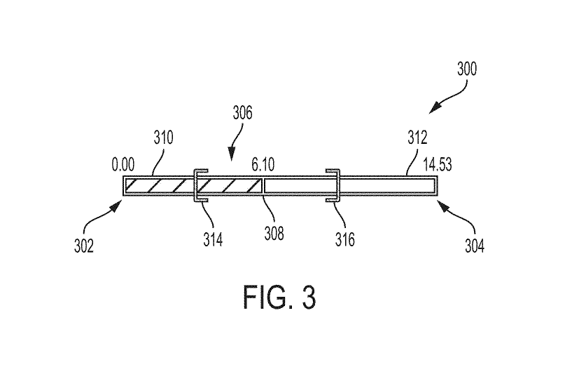

One illustrative example of a playback slider bar 300 is shown in FIG. 3. The illustrated playback slider bar 300 may include a start 302, an end 304, and a progress bar 306 disposed between the start and end. It should be understood, however, that other suitable configurations are contemplated in other embodiments. In the embodiment illustrated in FIG. 3, the total length of the selected musical work or clip is 14.53 seconds, as shown at the end 304, though it should be understood that any suitable length of musical work or clip is contemplated. As the selected music progresses through playback, a progress indicator 308 moves across the progress bar 306 from the start 302 to end 304. In the illustrated embodiment, the progress bar “fills in” as the progress indicator 308 moves across, resulting in a played portion 310 disposed between the start 302 and the progress indicator and an unplayed portion 312 disposed between the progress indicator and the end 304 of the musical clip. In the embodiment illustrated in FIG. 3, the progress indicator 308 has progressed across the progress bar 306 to the 6.10 second mark in the selected musical clip. Although the embodiment illustrated in FIG. 3 shows the progress bar 306 being filled in as the progress indicator 308 moves across it, other suitable mechanisms for indicating playback progress of a musical work or clip are also contemplated herein.

In some embodiments, such as the embodiment illustrated in FIG. 3, the user may place brackets, such as a first bracket 314 and a second bracket 316, around a subset of the selected musical phrase/melody along the progress bar 306. The brackets 314, 316 may indicate the portions of the musical work or clip to be utilized as the musical input at 208 in FIG. 2. For example, the first bracket 314 may indicate the “start” point for the selected musical input, and the second bracket 316 may indicate the “end” point. Other potential user interfaces that may facilitate user playback and selection of a subset of the musical phrase may be used instead of or in conjunction with the embodiment of the playback slider bar 300 of FIG. 3.

As would be understood by those in the art having the present specification before them, it may be possible for the user to select a musical work, phrase, or melody first and then later input their desired text or lyrics, or vice versa, while still capturing the essence of the present invention.

Once a user selects the desired musical work or clip to be used as the musical input for the user's musical work, the client device 101-105 may transmit the selection over the wireless network 106 and/or network 110, which may be received by the server 108 as the musical input at 208 of FIG. 2. At 210, the musical input may be analyzed and processed in order to identify certain characteristics and patterns associated with the musical input so as to more effectively match the musical input with the lyrical input to produce an original musical composition for use in a message or otherwise. For example, in some embodiments, analysis and processing of the musical work includes “reducing” or “embellishing” the musical work. In some embodiments, the selected musical work may be parsed for features such as structurally important notes, rhythmic signatures, and phrase boundaries. In embodiments that utilize a text or speech parser as described above, the results of the text or speech parsing may be factored into the analysis of the musical work as well. During analysis and processing, each musical work or clip may optionally be embellished or reduced, either adding a number of notes to the phrase in a musical way (embellish), or removing them (reduce), while still maintaining the idea and recognition of the original melody in the musical input. These embellishments or reductions may be performed in order to align the textual phrases in the lyrical input with the musical phrases by aligning their boundaries, and also to provide the musical material necessary for the alignment of the syllables of individual words to notes resulting in a natural musical expression of the input text. It is contemplated that, in some embodiments, all or part of the analysis of the pre-recorded musical works may have already been completed enabling the media generation system to merely retrieve the pre-analyzed data from the media database 109 for use in completing the musical composition. The process of analyzing the musical work in preparation for matching with the lyrical input and for use in the musical message is set forth in more detail below.

Subsequently to the analysis of the musical input, at 212, the lyrical input and the musical input may be correlated with one another based on the analyses of both the lyrical input and the musical input 206 and 210. Specifically, in some embodiments, the notes of the selected and analyzed musical work are intelligently and automatically assigned to one or more phonemes in the input text, as described in more detail below. In some embodiments, the resulting data correlating the lyrical input to the musical input may then be formatted into a synthesizer input at 214 for input into a voice synthesizer. The formatted synthesizer input, in the form of text syllable-melodic note pairs, may then be sent to a voice synthesizer at 216 to create a vocal rendering of the lyrical input for use in an original musical work that incorporates characteristics of the lyrical input and the musical input. The musical message or vocal rendering may then be received by the server 108 at 218. In some embodiments, the generated musical work may be received in the form of an audio file including a vocal rendering of the lyrical input entered by the user correlating with the music/melody of the musical input, either selected or created. In some embodiments, the voice synthesizer may generate the entire musical work including the vocal rendering of the lyrical input and the musical portion from the musical input. In other embodiments, the voice synthesizer may generate only a vocal rendering of the input text created based on the synthesizer input, which may be generated by analyzing the lyrical input and the musical input described above. In such embodiments, a musical rendering based on the musical input, or the musical input itself, may be combined with the vocal rendering to generate a musical work.

The voice synthesizer may be any suitable vocal renderer. In some embodiments, the voice synthesizer may be cloud-based with support from a web server that provides security, load balancing, and the ability to accept inbound messages and send outbound musically-enhanced messages. In other embodiments, the vocal renderer may be run locally on the server 108 itself or on the client device 101-105. In some embodiments, the voice synthesizer may render the formatted lyrical input data to provide a text-to-speech conversion as well as singing speech synthesis. In one embodiment, the vocal renderer may provide the user with a choice of a variety of voices, a variety of voice synthesizers (including but not limited to HMM-based, diphone or unit-selection based), or a choice of human languages. Some examples of the choices of singing voices are gender (e.g., male/female), age (e.g., young/old), nationality or accent (e.g., American accent/British accent), or other distinguishing vocal characteristics (e.g., sober/drunk, yelling/whispering, seductive, anxious, robotic, etc.). In some embodiments, these choices of voices may be implemented through one or more speech synthesizers each using one or more vocal models, pitches, cadences, and other variables that may result in perceptively different sung attributes. In some embodiments, the choice of voice synthesizer may be made automatically by the system based on analysis of the lyrical input and/or the musical input for specific words or musical styles indicating mood, tone, or genre. In certain embodiments, after the voice synthesizer generates the musical message, the system may provide harmonization to accompany the melody. Such accompaniment may be added into the message in the manner disclosed in pending U.S. Pat. No. 8,779,268, incorporated by reference above.

In some embodiments, the user may have the option of adding graphical elements to the musical work at 219. If selected, graphical elements may be chosen from a library of pre-existing elements stored either at the media database 109, on the client device 101-105 itself, or both. In another embodiment, the user may create its own graphical element for inclusion in a generated multimedia work. In yet other embodiments, graphic elements may be generated automatically without the user needing to specifically select them. Some examples of graphics that may be generated for use with the musical work may be colors and light flashes that correspond to the music in the musical work, animated figures or characters spelling out all or portions of textual message or lyrics input by the user, or other animations or colors that may be automatically determined to correspond with the tone of the musical input or with the tone of the lyrical input itself as determined by analysis of the lyrical input. If the user selects or creates a graphical element, a graphical input indicating this selection may be transmitted to and received by the server 108 at 220. The graphical element may then be generated at 222 using either the pre-existing elements selected by the user, automatic elements chosen by the system based on analysis of the lyrical input and/or the musical input, or a graphical elements provided by the user.

In some embodiments, the user may choose, at 224, to include a video element to be paired with the musical work, or to be stored along with the musical work in the same media file output. If the user chooses to include a video element, the user interface may activate one or more cameras that may be integrated into the client device 101-105 to capture video input, such as front-facing or rear-facing cameras on a smartphone or other device. In some embodiments, the user may manipulate the user interface on the client device to record video inputs to be incorporated into the generated musical. In some embodiments, the user interface displayed on the client device 101-105 may provide playback of the generated musical work while the user captures the video inputs allowing the user to coordinate particular features of the video inputs with particular portions of the musical work. In one such embodiment, the user interface may display the text of the lyrical input on the device's screen with a progress indicator moving across the text during playback so as to provide the user with a visual representation of the musical work's progress during video capture. In yet other embodiments, the user interface may allow the user to stop and start video capture as desired throughout playback of the musical work, while simultaneously stopping playback of the musical work. One such way of providing this functionality may be by capturing video while the user touches a touchscreen or other input of the client device 101-105, and at least temporarily pausing video capture when the user releases the touchscreen or other input. In such embodiments, the system may allow the user to capture certain portions of the video input during a first portion of the musical work, pause the video capture and playback of the musical work when desired, and then continue capture of another portion of the video input to correspond with a second portion of the musical work. After video capture is complete, the user interface may provide the option of editing the video input by re-capturing portions of or the entirety of the video input.

In some embodiments, once capture and editing of the video input is complete, the video input may be transmitted to and received by the server 108 for processing at 226. The video input may then be processed to generate a video element at 228, and the video element may then be incorporated into the musical work to generate a multimedia musical work. Once completed, the video element may be synced and played along with the musical work corresponding to an order in which the user captured the portions of the video input. In other embodiments, processing and video element generation may be completed on the client device 101-105 itself without the need to transmit video input to the server 108.

If the user chooses not to add any graphical or video elements to the musical work, or once the video and/or graphical elements have been generated and incorporated into the musical work to generate a multimedia work, the musical work or multimedia work may be transmitted or outputted, at 230, to the client device 101-105 over the network 110 and/or wireless network 110. In embodiments where all or most of the described steps may be executed on a single device, such as the client device 104, the musical work may be outputted to speakers and/or speakers combined with a visual display. At that point, in some embodiments, the system may provide the user with the option of previewing the musical or multimedia work at 232. If the user chooses to preview the work, the musical or multimedia work may be played at 234 via the client device 101-105 for the user to review. In such embodiments, if the user is not satisfied with the musical or multimedia work, or would like to create an alternative work for whatever reason, the user may be provided with the option to cancel the work without sending or otherwise storing, or to edit the work further. If, however, the user approves of the musical or multimedia work, or opts not to preview the work, the user may store the work as a media file, send the work as a musical or multimedia message to a selected message recipient, etc., at 235. As discussed above, the musical or multimedia work may be sent to one or more recipients using a variety of communications and social media platforms, such as SMS or MMS messaging, e-mail, Facebook®, Twitter®, and Instagram®, so long as the messaging service/format supports the transmission, delivery, and playback of audio and/or video files.

In some embodiments, a method of generating a musical work may additionally include receiving a selection of a singer corresponding to at least one voice characteristic. In some embodiments, the at least one voice characteristic may be indicative of a particular real-life or fictional singer with a particular recognizable style. For example, a particular musician may have a recognizable voice due to a specific twang, falsetto, vocal range, vibrato style, etc. When the system receives a selection of the particular singer, the at least one voice characteristic may be incorporated into the performance of the musical work. It is contemplated that, in some embodiments, the at least one voice characteristic may be included in the formatted data sent to the voice synthesizer at 216 of the method 200 in FIG. 2. However, it is also contemplated that the at least one voice characteristic may be incorporated into the vocal rendering received from the voice synthesizer.

The following provides a more detailed description of the methodology used in analyzing and processing the lyrical input and musical input provided by the user to create a musical or multimedia work. Specifically, the details provided pertain to at least one embodiment of performing steps 206 and 210-214 of the method 200 for operating the media generation system 100. It should be understood, however, that other alternative methodologies for carrying out the steps of FIG. 2 are contemplated herein. It should also be understood that the media generation system can perform the following operations automatically upon receiving a lyrical input and selection of musical input from a user via the user's client device. It should further be understood that the methodology disclosed herein provides technical solutions to technical problems associated with correlating lyrical inputs with musical inputs such that the musical output of the correlation of the two inputs is matched effectively. Further, the methods and features described herein can operate to improve the functional ability of the computer or server to process certain types of information in a way that makes the computer more usable and functional than would otherwise be possible without the operations and systems described herein.

The media generation system may gather and manipulate text and musical inputs in such a way to assure system flexibility, scalability, and effectiveness. In some embodiments, collection and analysis of data points relating to the lyrical input and musical input is implemented to improve the computer and the system's ability to effectively correlate the musical and lyrical inputs. Some data points determined and used by the system in analyzing and processing a lyrical input, such as in step 206, may be the number of characters, or character count (“CC”), and the number of words, or word count (“WC”) included in the lyrical input. Any suitable method may be used to determine the CC and WC. For example, in some embodiments the system may determine WC by counting spaces between groups of characters, or by recognizing words in groups of characters by reference to a database of known words in a particular language or selection of languages. Other data points determined by the system during analysis of the lyrical input may be the number of syllables, or syllable count (“TC”) and the number of sentences, or sentence count (“SC”). TC and SC may be determined in any suitable manner, for example, by analyzing punctuation and spacing for SC, or parsing words into syllables by reference to a word database stored in the media database 109 or elsewhere. Upon receipt of the lyrical input that may be supplied by a user via the client device 101-105, the system may analyze and parses the input text to determine values such as the CC, WC, TC, and SC. In some embodiments, this parsing may be conducted at the server 108, but it is also contemplated that, in some embodiments, parsing of the input text may be conducted on the client device 101-105. In certain embodiments, during analysis, the system may insert coded start flags and end flags at the beginning and end of each word, syllable, and sentence to mark the determination made during analysis. The location of a start flag at the beginning of a sentence, for example, may be referred to as the sentence start (“SS”), and the location of the end flag at the end of a sentence may be referred to as the sentence end (“SE”). Additionally, it is contemplated that, during analysis, words or syllables of the lyrical input may be flagged for a textual emphasis. The system methodology for recognizing such instances in which words or syllables should receive textual emphasis may be based on language or be culturally specific.

In some embodiments, another analysis conducted by the system on the input text may be determining the phrase class (“PC”) of each of the CC and the WC. The phrase class of the character count will be referred to as the CCPC and the phrase class of the word count will be referred to as the WCPC. The value of the phrase class may be a sequentially indexed set of groups representing increasing sets of values of CC or WC. For example, a lyrical input with CC of 0 may have a CCPC of 1, and a lyrical input with a WC of 0 may have a WCPC of 1. Further, a lyrical input with a CC of between 1 and 6 may have a CCPC of 2, and a lyrical input with a WC of 1 may have a WCPC of 2. The CCPC and WCPC may then increase sequentially as the CC or the WC increases, respectively.

Below, Table 1 illustrates, for exemplary and non-limiting purposes only, a possible classification of CCPC and WCPC based on CC and WC in a lyrical input.

TABLE 1

| PC | CC | WC | Description |
|---|---|---|---|
| 1 | 0 | 0 | No Lyrical input |
| 2 | 1-6 | 1 | One Word |
| 3 | 7-9 | 2-3 | Extremely Short |
| 4 | 10-25 | 4-8 | Short |
| 5 | 25-75 | 9-15 | Medium |
| 6 | 75-125 | 15-20 | Long |
| 7 | 125+ | 20+ | Extremely Long |

Based on the CCPC and WCPC, the system may determine an overall phrase class for the entire lyrical input by the user, or the user phrase class (“UPC”). This determination may be made by giving different weights to different values of CCPC and WCPC, respectively. In some embodiments, greater weight may be given to the WCPC than the CCPC in determining the UPC, but it should be understood that other or equal weights may also be used. One example gives the CCPC a 40% weight and the WCPC a 60% weight, as represented by the following equation:

UPC=0.4(CCPC)+0.6(WCPC) EQ. 1

Thus, based on the exemplary Table 1 of phrase classes and exemplary equation 1 above, a lyrical input with a CC of 27 and a WC of 3 may have a CCPC of 5 and a WCPC of 3, resulting in a UPC of 3.8 as follows:

UPC=0.4(5)+0.6(3)=3.8 EQ. 2

It should be noted that the phrase class system and weighting system explained herein m variable based on several factors related to the selected musical input such as mood, genre, style, etc., or other factors related to the lyrical input, such as important words or phrases as determined during analysis of the lyrical input.

In an analogous manner, the musical input selected or provided by the user may be parsed during analysis and processing, such as in step 210 of FIG. 2. In some embodiments, the system may parse the musical input selected or provided by the user to determine a variety of data points. One data point determined in the analysis may be the number of notes, or note count (“NC”) in the particular musical input.

Another product of the analysis that may be done on the musical input may include determining the start and end of musical phrases throughout the musical input. A musical phrase may be analogous to a linguistic sentence in that a musical phrase is a grouping of musical notes that conveys a musical thought. Thus, in some embodiments, the analysis and processing of the selected musical input may involve flagging the beginnings and endings of each identified musical phrase in a musical input. Analogously to the phrase class of the of the lyrical input (UPC) described above, a phrase class of the source musical input, referred to as source phrase class (“SPC”) may be determined, for example, based on the number of musical phrases and note count identified in the musical input.

The beginning of each musical phrase may be referred to as the phrase start (“PS”), and the ending of each musical phrase may be referred to as the phrase end (“PE”). The PS and the PE in the musical input may be analogous to the sentence start (SS) and sentence end (SE) in the lyrical input. In some embodiments, the PS and PE associated with the preexisting musical works may be pre-recorded and stored on the server 108 or the client device 101-105, where they may be available for selection by the user as a musical input. In such embodiments, the locations of PS and PE for the musical input may be pre-determined and analysis of the musical input involves retrieving such information from a store location, such as the media database 109. In other embodiments, however, or in embodiments where the musical input is provided by the user and not pre-recorded and stored, further analysis is conducted to distinguish musical phrases in the musical input and, thus, determine the corresponding PS and PE for each identified musical phrase.

In some embodiments, the phrase classes of the lyrical input and the musical input are compared to determine the parity or disparity between the two inputs. It should be understood that, although the disclosure describes comparing corresponding lyrical inputs and musical inputs using phrase classes, other methodologies for making comparisons between lyrical inputs and musical inputs are contemplated herein. The phrase class comparison can take place upon correlating the musical input with the lyrical input based on the respective analyses, such as at step 212.

In certain embodiments, parity between a lyrical input and a musical input is analyzed by determining the phrase differential (“PD”) between corresponding lyrical inputs and musical inputs provided by the user. One example of determining the PD is by dividing the user phrase class (UPC) by the source phrase class (SPC), as shown in Equation 3, below:

PD=UPC/SPC EQ. 3

In this example, perfect phrase parity between the lyrical input and the musical input would result in a PD of 1.0, where the UPC and the SPC are equal. If the lyrical input is “shorter” than the musical input, the PD may have a value less than 1.0, and if the lyrical input is “longer” than the musical input, the PD may have a value of greater than 1.0. Those with skill in the art will recognize that similar results could be obtained by dividing the SPC by the UPC, or with other suitable comparison methods.

Parity between the lyrical input and the musical input may also be determined by the “note” differential (“ND”) between the lyrical input and the musical input provided by the user. One example of determining the ND is by taking the difference between the note count (NC) and the analogous syllable count (TC) of the lyrical input. For example:

ND=NC−TC EQ. 4

In this example, perfect phrase parity between the lyrical input and the musical input would be an ND of 0, where the NC and the TC are equal. If the lyrical input is “shorter” than the musical input, the ND may be greater than or equal to 1, and if the lyrical input is “longer” than the musical input, the ND may be less than or equal to −1. Those with skill in the art will recognize that similar results could be obtained by subtracting the NC from the TC, or with other suitable comparison methods.

Using these or suitable alternative comparison methods establishes how suitable a given lyrical input is for a provided or selected musical input. Phrase parity of PD=1 and ND=0 may represent a high level of parity between the two inputs, where PD that is much greater or less than 1 or ND that is much greater or less than zero may represent a low level of parity, i.e., disparity. In some embodiments, when correlating the musical input and the lyrical input to create a musical work, the sentence starts (SS) and sentence ends (SE) of the lyrical input may align with the phrase starts (PS) and phrase ends (PE), respectively, of the musical input if the parity is perfect or close to perfect (i.e., high parity). However, when parity is imperfect, the SE and the PE may not align well when the SS and the PS are set aligned to one another. Based on the level of parity/disparity determined during analysis, various methods of processing the musical input and the lyrical input can be utilized to provide an optimal outcome for the musical work. In some embodiments, these techniques or editing tools may be applied automatically by the system, or may be manually applied by a user.

One example of a solution to correlate text and musical inputs is syllabic matching. When parity is perfect, i.e., note differential (ND) is zero, the note count (NC) and the syllable count (TC) may be equal or the phrase differential (PD) may be 1.0, syllabic matching may involve simply matching the syllables in the lyrical input to the notes in the musical input and/or matching the lyrical input sentences to the musical input musical phrases.

The media generation system 100 may provide techniques to increase or optimize note parity by minimizing the absolute value of note differential in a musical work to be output. Among other things, optimizing note parity may also maximize the recognizability of the melody chosen or otherwise provided as the musical input by, for example, making the number of notes as close as possible to the source note count. For example, in some embodiments, if PD is slightly greater than or less than to 1.0 and/or ND is between, for example, 1 and 5 or −1 and −5, melodic reduction or embellishment, respectively, may be used to provide correlation between the inputs. Melodic reduction involves reducing the number of notes played in the musical input and may be used when the NC is slightly greater than the TC (e.g., ND is between approximately 1 and 5) or the musical source phrase class (SPC) is slightly greater than the user phrase class (UPC) (e.g., PD is slightly less than 1.0). Reducing the notes in the musical input may shorten the overall length of the musical input and result in the NC being closer to or equal to the TC of the lyrical input, improving the phrase parity. The fewer notes that are removed from the musical input, the less impact the reduction will have on the musical melody selected as the musical input and, therefore, the more recognizable the musical element of the musical work may be upon completion. Similarly, melodic embellishment involves adding notes to (i.e., “embellishing”) the musical input. In some embodiments, melodic embellishment is used when the NC is slightly less than the TC (e.g., ND is between −1 and −5) or the SPC is slightly less than the UPC (e.g., PD is slightly greater than 1.0). Adding notes in the musical input may lengthen the musical input, which may add to the NC or SPC and, thus, increase the parity between the inputs.

The fewer notes that are added using melodic embellishment, the less impact the embellishment will have on the musical melody selected as the musical input and, therefore, the more recognizable the musical element of the musical work will be once it is generated. In some embodiments, the additional notes added to the musical work may be determined by analyzing the original notes in the musical input and adding notes that make sense musically. For example, in some embodiments, the system may only add notes in the same musical key as the original work in the musical input, or notes that maintain the tempo or other features of the original work so as to aide in keeping original work recognizable. It should be understood that although melodic reduction and embellishment have been described in the context of slight phrase disparity between the musical and lyrical inputs, use of melodic reduction and embellishment in larger or smaller phrase disparity is also contemplated.

In some embodiments, the system 100 may also include determining the most probable melodic embellishment by utilizing supervised learning on a modified Probabilistic Context-Free Grammar. In such embodiments, a set of melodic embellishment rules may be implemented that may encode many of the common surface-level forms of melodic composition. The melodic embellishment rules may be broken out into two-note rules, three-note rules, and four-note rules. The two-note rules may include suspension, anticipation, and consonant skip. The three-note rules may include passing tone, neighbor tone, appoggiatura, and escape tone. The four-note rules may include at least passing tone. In some embodiments, each rule may receive a window of notes as its input, such as two notes, three notes, or four notes. Using the rules that fall into the corresponding note number in the melodic reduction rules, the grammar may identify the notes that are most likely embellishments of the neighboring notes. As such, embellished notes may be reduced out and removed from the melody, or embellishments may be added as appropriate. In some embodiments, the process may continue until the melody for the musical input is reduced to a single note or embellished beyond an intelligible note density. The result may be a tree of melodic embellishments where each node may be a note that is hierarchically placed by the embellishment rules. In some embodiments, the process above may be executed once the grammar has been trained using the statistics of existing compositions or the corresponding reductions thereof. For example, a database may be utilized that includes existing melodies that have been analyzed and their entire reductive trees encode in Extensible Mark-up Language (XML).

As described above, melodic reduction may work best in situations where the Note Differential is relatively low. In some embodiments, the system may define a threshold under which melodic reduction should not be applied. The threshold may not be static, but instead may be relative to the size of the melodic phrase being reduced. In some embodiments, the threshold may be modified through configuration options. For example, in some embodiments, the default threshold may be 80%. In such embodiments, melodic reduction may be used alone to achieve note parity when the input text has a syllable count (TC) that is 80% or more of the note count (NC). In other embodiments, the default threshold may be 70%, 75%, 85%, 90%, or 95%.

The below XML code may be an example of training data as described herein:

<MelodicSkeleton lickID=‘SafeAndSound/2’>
<Embellishment type=“CONSONANT_SKIP_LEFT”>

<startNoteIndex val=“2”/>
<embellishedNoteIndex val=“4”/>
<ChildEmbellishments>

<Embellishment type=“REPEAT_RIGHT”>

<startNoteIndex val=“2”/>
<embellishedNoteIndex one=“0”/>
<ChildEmbellishments>

<Embellishment type=“REPEAT_LEFT”>

<startNoteIndex val=“0”/>
<embellishedNoteIndex one=“1”/>
<ChildEmbellishments>

<Embellishment
type=“NO_EMBELLISHMENT”>

<startNoteIndex val=“0”/>
<nextNoteIndex val=“1”/>

</Embellishment>
<Embellishment
type=“NO_EMBELLISHMENT”>

<startNoteIndex val=“1”/>
<nextNoteIndex val=“2”/>

</Embellishment>

</ChildEmbellishments>

</Embellishment>
<Embellishment type=“NO_EMBELLISHMENT”>

<startNoteIndex val=“2”/>
<nextNoteIndex val=“3”/>

</Embellishment>

</ChildEmbellishments>

</Embellishment>
<Embellishment type=“REPEAT_RIGHT”>

<startNoteIndex val=“4”/>
<embellishedNoteIndex one=“3”/>
<ChildEmbellishments>

<Embellishment type=“NO_EMBELLISHMENT”>

<startNoteIndex val=“3”/>
<nextNoteIndex val=“4”/>

</Embellishment>
<Embellishment type=“NO_EMBELLISHMENT”>

<startNoteIndex val=“4”/>
<nextNoteIndex val=“5”/>

</Embellishment>

</ChildEmbellishments>

</Embellishment>

</ChildEmbellishments>

</Embellishment>
</MelodicSkeleton>

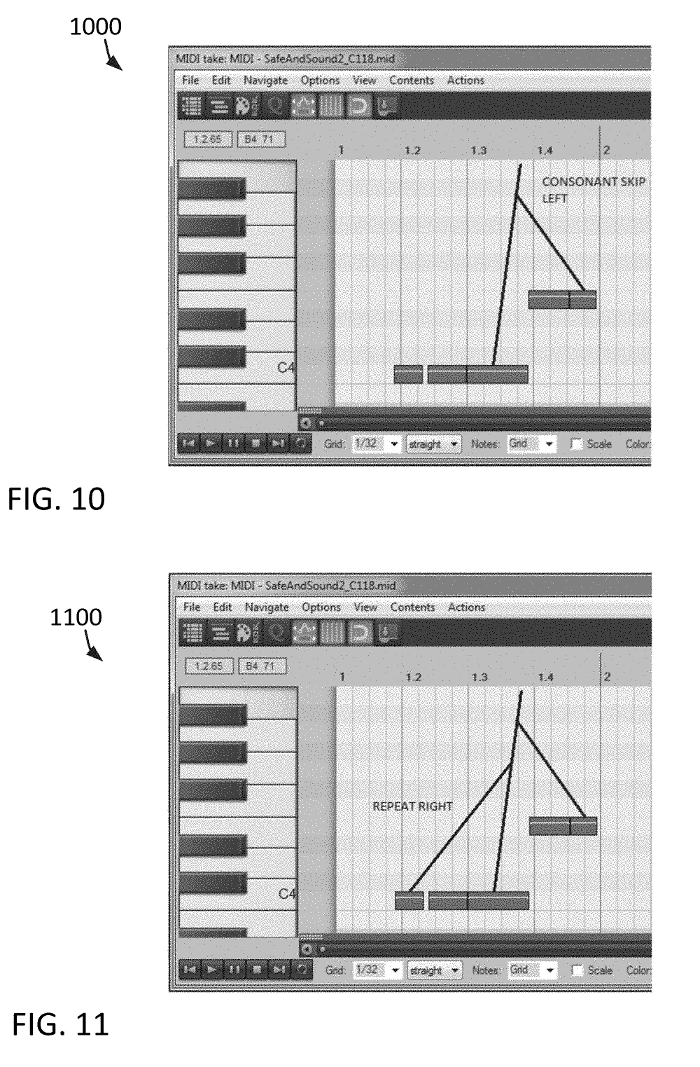

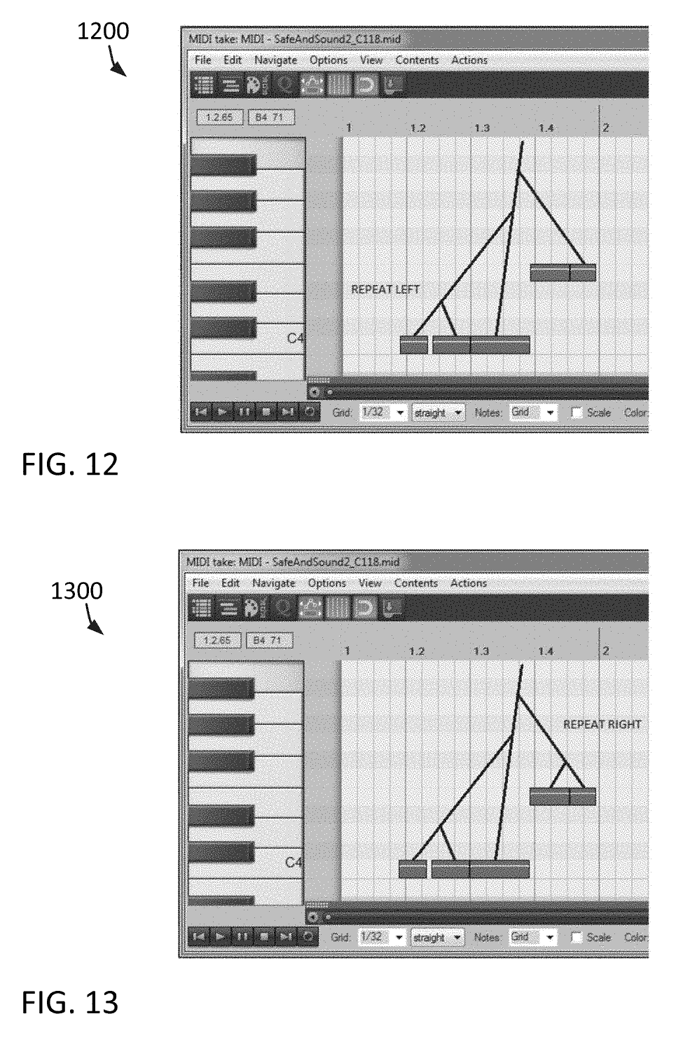

At a very high level, FIGS. 10-13 show an example graphical user interface (GUI) illustrating an embodiment of the example training data. For example, FIG. 10 shows an example GUI 1000 of a CONSONANT_SKIP_LEFT embellishment from note index 2 (the 3rd note, 0-indexed) to note index 4 (the 5th note). In this example, the left note of the tope embellishment (note index 2) may then be further embellished. FIG. 11 shows an example GUI 1100 of a REPEAT RIGHT embellishment from the first note (of index 0). FIG. 12 then shows an example GUI 1200 showing that the first note may be further embellished by a REPEAT LEFT embellishment because of the second note. Then, in the example XML, it is specified that the right note of the uppermost embellishment, the CONSONANT_SKIP_LEFT (note index 4) may be similarly embellished further by a REPEAT_RIGHT embellishment, completing the entire reduction for this example embodiment. This is shown in GUI 1300 of FIG. 13.

It is contemplated that each embellishment may gather a number of situations in which it can be applied. The notes that may be embellished as well as the structural tones on which they rely may be measured, including the interval measurements between each note in the embellishment figure. In some embodiments, the interval-onset intervals may be the difference in time between the onset of one note, and the onset of the note following it in a musical monophonic sequence. In some embodiments, using such measurements, the system may group similar melodic situations and apply the same reduction or embellishment to those situations.

Another solution to resolving disparity between the musical input and the lyrical input may be stutter effects. In some embodiments, stutter effects may be used to address medium parity differentials—e.g., a PD between approximately 0.75 and 1.5. Stutter effects may involve cutting and repeating relatively short bits of a musical or vocal work in relatively quick succession. Stutter effects may be applied to either the musical input or to the lyrical input in the form of vocal stutter effects in order to lengthen one or the other input to more closely match the corresponding musical or lyrical input. For example, if a musical input is shorter than a corresponding lyrical input (e.g., PD is approximately 1.5), the musical input could be lengthened by repeating a small portion or portions of the musical input in quick succession. A similar process may be used with the lyrical input, repeating one or more syllables of the lyrical input in relatively quick succession to lengthen the lyrical input. As a result of the stutter effects, the phrase differential between the musical input and the lyrical input may be brought closer to the optimal level. It should be understood that although stutter effects have been described in the context of medium phrase disparity between the musical and lyrical inputs, use of stutter effects in larger or smaller phrase disparity is also contemplated.

Other solutions to resolving disparity between the musical input and the lyrical input may be repetition and melisma. In some embodiments, repetition and melisma may be used to resolve relatively large phrase differentials between musical and lyrical inputs—e.g., a PC less than 0.5 or greater than 2.0. Repetition includes repeating either the lyrical input or the musical input more than once while playing the corresponding musical or lyrical input a single time. For example, if the PD is 0.5, this may indicate that musical input is twice as long as the lyrical input. In such a scenario, the lyrical input could simply be repeated once (i.e., played twice), to substantially match the length of the musical input. Similarly, a PD of 2.0 may indicate that that the lyrical input is substantially twice as long as the musical input. In such a scenario, the musical input could be looped to play twice to correlate with the single playback of the longer lyrical input.

Melisma is another solution that may be used to resolve disparity between musical inputs and corresponding lyrical inputs. In some embodiments, melisma may be used when the lyrical input is shorter than the musical input to make the lyrical input more closely match with the musical input. Specifically, melisma may occur when a single syllable from the lyrical input is stretched over multiple notes of the musical input. For example, if the syllable count (TC) is 12 and the note count (NC) is 13, the system may assign one syllable from the lyrical input to be played or “sung” over two notes in the musical input. Melisma can be applied over a plurality of separate syllables throughout the lyrical input, such as at the beginning, middle, and end of the musical input.

In some embodiments, the system may choose which words or syllables to which a melisma should be applied based on analysis of the words in the lyrical input and/or based on the tone or mood of the musical work chosen as the musical input. For example, specific phoneme combinations may be included in a speech syntheses engine's lexicon. In a specific example, the word “should” may be broken down in a tokenization process into the phoneme “sh”, “uh”, and “d”. New words may be added to the speech syntheses engine's lexicon representing the word “should” as it may be sung over multiple notes. So, the speech synthesis engine may recognize, for example, the “sh” phoneme as a word in its lexicon. Further, if melisma of length three or more (extending over three or more notes) was desired, the lexicon could include: “shouldphon1” for [“sh” “uh”], “shouldphon2” for [“uh”], and “shouldphon3” for [“uh” “d”]. The synthesis engine may then recognize where a melisma has been marked in the interface XML, and use these “words” when invoking the separated syllables for the word “should.”

In some embodiments, the system may identify locations where melisma may be helpful by analyzing the difference between two notes. A “metric level” is a hierarchy of metrical organization created to differentiate the meter of the onset of notes, based on a 4/4 meter. A note on beat one, on the downbeat, may be given the Metric Level of 1, the downbeat of beat 3 may be level 2, the downbeat of both beat 2 and beat 4 may be assigned to level 3, all of the upbeats of a given measure may be assigned the level of 4, 16th notes may be level 5, and 32nd notes may be level 6. The “metric interval” may be the difference between two consecutive metric levels. The “chord-tone level” may be another assigned hierarchy, where the root of the chord is level 1, the fifth of the chord is level 2, and the third is level 3. Triads are assumed. Finally, the “chord-tone interval” may be the difference between two consecutive chord-tone levels. In some embodiments, based on the metric level, the duration, and the chord-tone level, the system may estimate the difference in prominence between two consecutive notes. A large positive prominence differential may mean that the first note may be more rhythmically and harmonically prominent than the following note, while a negative prominence differential may be the opposite. Furthermore, melismas may not possible between two consecutive notes of the same pitch (or, at least, would not be recognizable in the synthesized vocal output), so those situations may not be considered in some embodiments. Additionally, in some embodiments, melismas may be limited to 1 or 2 semitones, with anything above that excluded.

Based on the above, the system may execute methods for identifying situations in the text where may be advantageous to insert a melisma and calculate a text melisma score. For example, syllables that are accented, and correspondingly may be marked with a stress tag of “1” during a tokenization process may be better candidates for melisma. In some embodiments, syllables identified for melisma may contain a vowel that is extensible (e.g. some vowel sounds, like “ay” may not sound as good as others when repeated) in order to be considered, and a score based on the two conditions may be computed. To find and apply melismas, the text melisma score may be combined with the note prominence score, and then a threshold may be used to decide whether or not a particular note should be extended by melisma. In one embodiment, melismas may be added from left to right along the length of the lyrical input until the number of melismas added attains note parity, or until there are no more melisma scores that are above the threshold.

Another solution to the disparity between lyrical input and musical input is recognizing leitmotifs in the musical input. One skilled in the art would recognize that leitmotifs are relatively smaller elements of a musical phrase that still include some “sameness” that may be discerned by the listener. The “sameness” may be a combination of similar or same rhythms and musical intervals repeated throughout a musical phrase. For example, a leitmotif may be a grouping of notes within a musical phrase that follows similar note patterns or note rhythms, and these leitmotifs may be recognized by the system during analysis or can be pre-determined for pre-recorded musical works. In either case, leitmotif locations throughout a musical input may be noted and marked. In some embodiments, leitmotifs may then be used as prioritized targets for textual emphasis or repetition when analyzing the musical input to resolve disparity between the musical input and the lyrical input.

In some embodiments, the system may use melodic phrase analysis and removal to optimize parity. In some embodiments, this may involve analysis using a repeated sequences boundary detector. Such a detector may analyze a musical input to identify every or most of the repeating subsequences of a melody. In some embodiments, the algorithm that may identify the repeating subsequences may identify a sequence representing a series of pitches or pitchclasses, a series of pitch intervals or pitchclass intervals, or a series of inter-onset intervals. A pitchclass may be the number of semitones from the nearest “C” note to the given pitch (where C is below the given note, yielding a positive number), and the pitch interval may be the difference in pitchclass from one pitch to the following pitch in a melodic sequence. In other words, the algorithm in such embodiments may identify every repeating subsequence of every possible length. The system may then output a set of repeated subsequences of which certain subsequences are more musically salient than others. The system may then use a formula to identify the more musically important subsequences, and assign each subsequence a score based on the formula. Each note that begins a particularly strong subsequence in the melody may be assigned a strength based on the score provided by the formula. Notes with higher boundary strengths may be the most likely places that a phrase boundary may occur. In some melodies, a phrase in a subsequence may be repeated with one or more notes added in between. As such, the phrase boundary detection algorithm described above may be combined with another algorithm for detecting large musical changes based on the concepts of Gestalt perception.

The Gestalt theory of human perception may be extended to music into perceptual boundary detection. In Gestalt, visual objects may be grouped based on the following principles: similarity, proximity, continuity, and closure. Musical events may be grouped in the same ways; for example, the system may group subsequences by focusing on similarity, proximity, and continuity. For example, in set of three notes in which the onset of the second note is a dotted quarter note away from the first note's onset, and the third note's onset is a single quarter note away from the second note's onset, the latter two notes can be grouped together, perceptually, because of the closeness of their onsets (proximity). Similarly, if the first note is of pitch C, and the latter two of pitch F, the latter two can be grouped together because of the principles of perceptual similarity. The system 100 may use the principle of continuity. The secondary algorithm that identifies phrase boundaries may work by comparing three consecutive intervals. If the middle interval is significantly different from both of the surrounding intervals, then it may more likely be a phrase boundary. In some embodiments, this may be estimated by the maximum degree of change for sets of three notes, computed over the entire melody. The degree of change may be normalized on the maximum degree of change, so that all of the degree of change values for each three-note set may be normalized between 0 and 1. In some embodiments, the intervals used for comparison may be based on three separate measurements: Pitch intervals, Inter-Onset Interval, and Offset-to-Onset Intervals. The normalized degree of change vectors may be computed over the melodic sequence for each measurement, and then may be combined into a single vector by a formula.

In some embodiments, the system may employ a phrase boundary detection algorithm by combining the two above processes. The algorithm may first use the repeated sequence boundary detector. This may yield a sparse vector which indicates the most likely places in the melody where subphrases might start based on the repetition in the melody. After this, each of the repeated phrase boundaries may be merged with the perceptual boundaries as set forth in the following example. The score for the repeated sequence boundary may be multiplied by the perceptual phrase boundary, and also by a measure of the distance between the two boundaries based on a tapered window (in number of notes). Thus, the system may search for the strongest boundary in the perceptual phrase boundary vector that may be as close as possible to the strong boundaries in the repeated phrase boundary vector. The system may then find the top n number of combined phrase boundaries. In some embodiments, n may set to 5, but may be other suitable values as well.

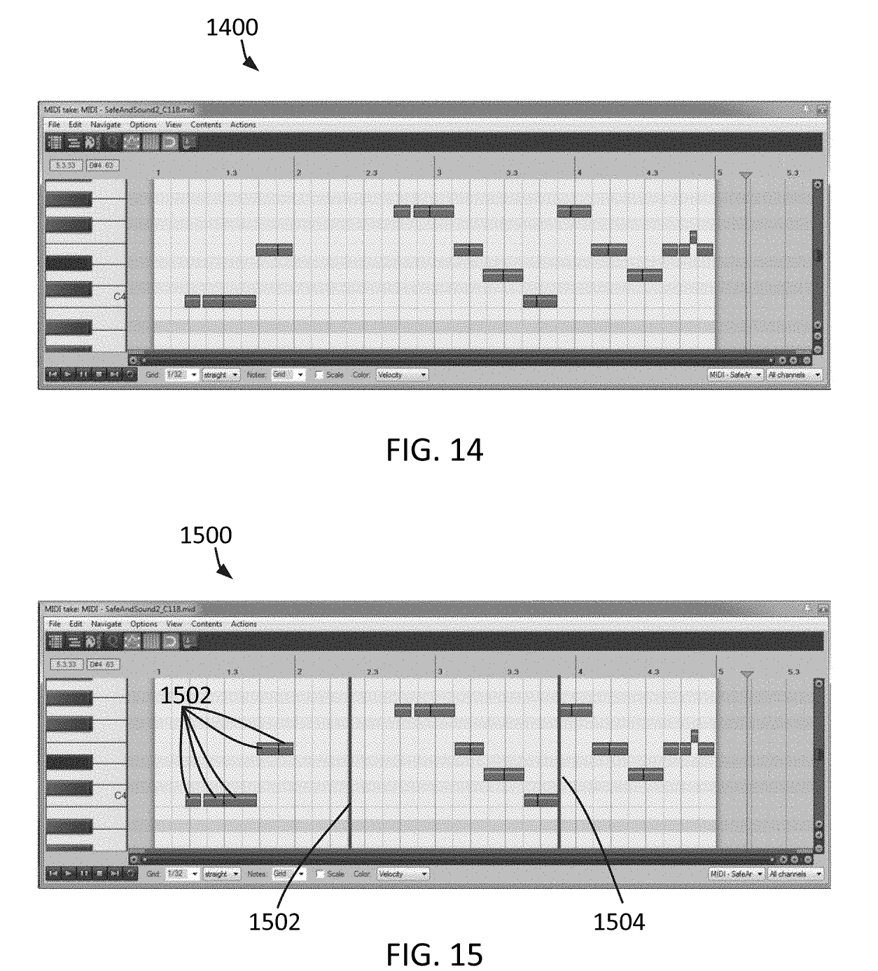

FIG. 14 shows an example graphical user interface 1400 applying an embodiment of the above-recited melodic phrase analysis process. The GUI shows a MIDI representation of a musical input. The system may use the diatonic index as a measure for repetition. The diatonic index is the number of diatonic steps from the root note of the current key signature, and the diatonic interval is the difference in diatonic indices for two consecutive notes. In the melody shown in FIG. 14, the vector of diatonic intervals may be as follows:
(0, 0, 2, 0, 2, 0, 0, −2, 0, −1, 0, 4, 0, −2, 0, −1, 0, 1, 1, −1).
   Analysis of the vector may indicate one repeated sequence that may have the highest strength; specifically, [0, −2, 0, −1, 0]. Many smaller repeated sequences (such as [0, 2, 0] or [−1, 0]), may also be considered but have smaller strengths. Boundary strengths may then be estimated to find the following:
(0.143, 0.197, 0.143, 0.197, 0.143, 0.143, 1, 0.643, 0.525, 0.321, 0.523, 0.321, 0, 0, 1, 0.643, 0.525, 0.321, 0, 0, 0, 0, 0)

Similarly, the perceptual phrase boundaries may be computed based on the discontinuity of a 3-note sliding window. The perceptual phrase boundary analysis may result in the following vector:
(0.033, 0.015, 0.032, 0.231, 0.079, 0.8, 0.048, 0.015, 0.125, 0.028, 0.078, 0.026, 0.078, 0.033, 0.325, 0.036, 0.125, 0.028, 0.078, 0.026, 0.054, 0.010, 0.004, 0.013)

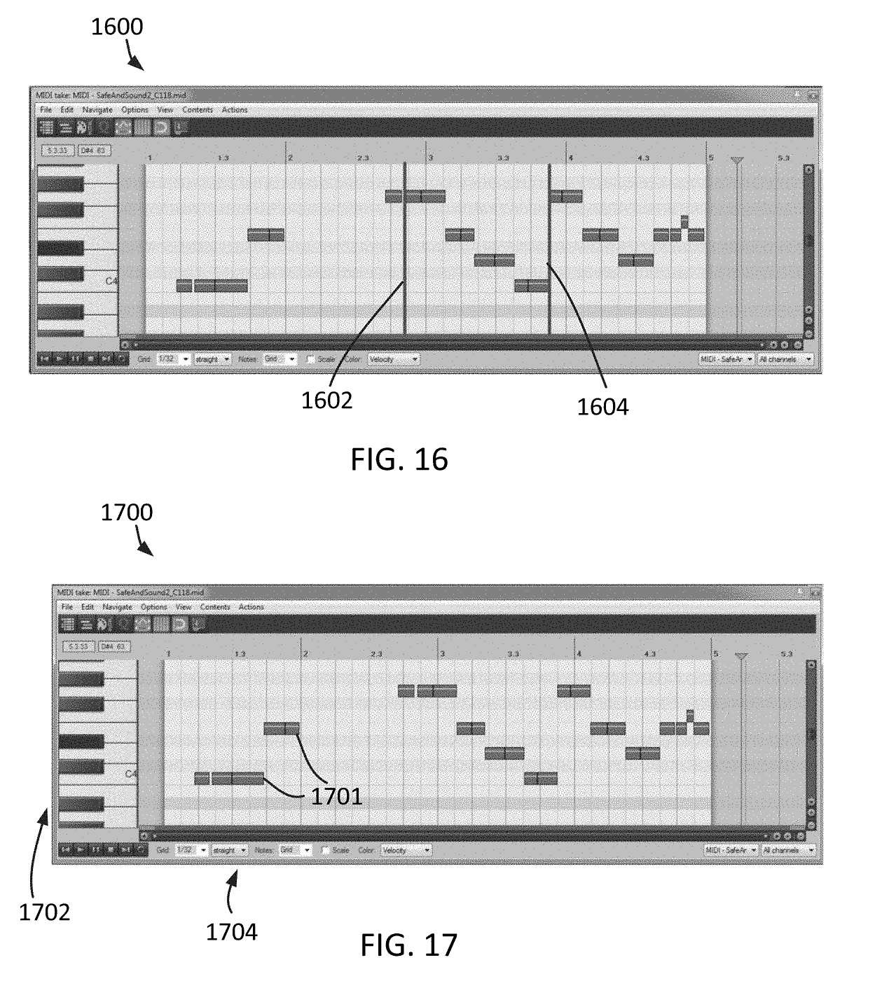

After combining the above two vectors, by computing the n=5 highest combined boundaries, the system may identify the following boundaries:
(0, 0, 0, 0, 0, 0.8, 0, 0, 0, 0, 0, 0, 0, 0, 0.325, 0, 0, 0, 0, 0, 0, 0, 0)
   FIG. 15 shows a GUI 1500 indicating an example of the identification of a first boundary 1502 and a second boundary 1504. Alternatively, FIG. 16 shows another example GUI 1600 indicating a first boundary 1602 and a second boundary 1604 that may have been identified if only the strongest repeated phrases were considered.

In some embodiments, based on the phrase analysis described above, the system may remove entire phrases when, for example, the Note Differential (ND) is largely negative. In the example provided above, if an input text was received with a syllable count of 5, the 2nd and 3rd phrase could then be removed, resulting in a melody with only 5 notes. Such an example would attain a Note Parity of exactly 1.

Another tool that may be implemented by the system to achieve note parity may be text alignment, which may utilize a combination of the tools described above. Text alignment may include aligning textual phrases in the lyrical input with their melodic phrase counterpart in the musical input. In some embodiments, text alignment may include implementing phrase analysis, text repetition, melismas, and then melodic reduction in combination. First, the melodic phrases may be extracted from the melody in the musical input. Then, for each textual phrase (which may be identified in the text tokenization process), the note differential may be calculated for the melodic phrase identified. In some embodiments, if the text repetition feature is available for the textual phrase, and if the repetition of text would bring the note parity above a melodic reduction threshold, (e.g., 0.8, or 0.9) and below 1, the text may be repeated. In such cases, melismas may be added to optimize parity (e.g., PD=1). If parity may not be attained through milasmas, then, in some embodiments, melodic reduction may be used to reduce the number of notes down to the phrase's number of syllables. The process may continue for each textual phrase of the lyrical input until the entirety of the lyrical input has been assigned to notes in the melody, even if somewhat modified.

FIGS. 15, 17, and 18 illustrate a series of GUIs for implementing an embodiment of text alignment in the manner described above. The GUIs may represent a visually depiction of MIDI notes 1701 with notes on the vertical axis 1702 and time on the horizontal axis 1704. For an example lyrical input of “That's cool, I like your costume better,” the text may be tokenized by a text analysis tool, identifying phrase breaks based on grammar and punctuation. For example, the break down may result in: [“That's cool”], [“I like your costume”], [“better”]. The first break between “That's cool” and “I like your costume” may be identified from the comma. The second break between “I like your costume” and “better” may be identified based on “I like your costume” being a grammatically complete sentence. As a result, “That's cool” may be made to correspond with the first melodic phrase in the musical input based on the phrase boundaries detected such as shown above in FIG. 15. Referring to FIG. 15, the first melodic phrase in the musical input (e.g., the notes 1501 before the first boundary 1502) contains five notes, while the first textual phrase, “That's cool”, contains only two syllables, resulting in a phrase differential or note parity of 0.4. Repeating the first phrase in the input text results in four syllables, or a phrase differential or note parity of 0.8. If the threshold for applying the text repetition tool is set at 80%, the note parity of 0.8 may meet the threshold and allow the text to be repeated. The melisma tool may then be applied. In this example, there are no situations for which melisma may be added as defined by the parameters discussed above with respect to melisma. In this example, the pitch intervals for the first melodic phrase may be (0, 0, 4, 0). In some embodiments, the melisma tool may only be applied for 1 or 2 semitones, so no melismas would be added in this example. However, it is contemplated that other less restrictive rules for melismas may be applied in other embodiments. Next, the melodic reduction tool may be used. In this embodiment, the most probable reduction based on the set of solutions that the melodic reduction grammar may be trained on, is the REPEAT LEFT embellishment from note index 1 to note index 0. Thus, in this example, the second note in the phrase may be removed, and the duration of the first note may be extended to the end of the second, now reduce-out note.

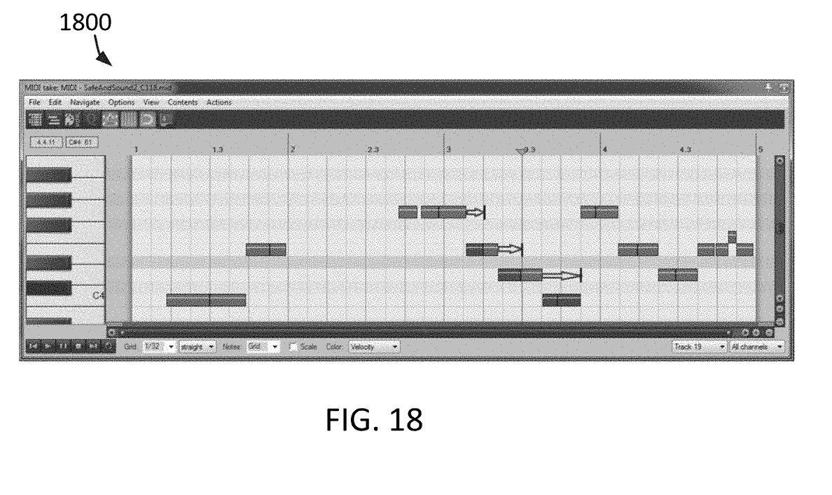

For the second textual phrase, “I like your costume,” the duplication of the text would result in a note parity of more than one, and thus may not be used in this embodiment. Therefore, melisma and the reduction tools may be used to optimize parity. In this example, a threshold of 0.8 parity may not be reached, and thus the output of the system for the given portion of the musical work may involve 4 notes removed in the reduction process. The notes preceding them may be extended, as depicted in GUI 1800 of FIG. 18. In this example, the third and final textual phrase is simply the word “better” containing two syllables, and the final melodic phrase contains nine notes. The text repetition feature may be invoked. The text may be repeated four times to yield a 0.888 note parity, which is above the 0.8 threshold for this example. So, the text may repeated four times. Then, the newly repeated text may be analyzed for possible melismas. A melisma opportunity may be found for the “er” of “better” extended over the fourth and third to last notes. In this portion of the input text, no reduction may be needed because, after adding one extra melisma syllable, optimal note parity may achieved for this phase.

In the example recited herein, the musical input has 23 notes, while the lyrical input was nine syllables. The application of the system's tools as described herein were used to optimize parity while only removing five notes from the musical input. Further, the notes removed were from different portions of the musical input. Thus, the recognizability of the original melody in the musical input may be preserved using the lyrics of the lyrical input.

The media generation system 100 may include additional features in generating a musical or multimedia work. As described above, some embodiments of the system may include allowing a user to create a melody to be used as a musical input. In such embodiments, a synthesized vocal melody generated from the input text may follow the specific melody created and defined by the user. The user may perform an original melody on a keyboard or input data through MIDI or other input devices to provide a melodic contour for the musical input. In some embodiments, the system 100 may then generate a vocal-like reference while playing, perform actual words or lyrics from a lyrical input in substantially real time, and may pass MIDI back to an external sound source. In some embodiments, user's may type or otherwise enter the lyrics the user would like included in a musical work a lyrical input. The lyrical input may then be transformed to automatically assign notes, embellishments, and/or other effects such as those described herein. In some embodiments, a user may change the lyrics or words in the lyrical input at any time and the system may automatically adjust the musical work or a section of the musical work accordingly.

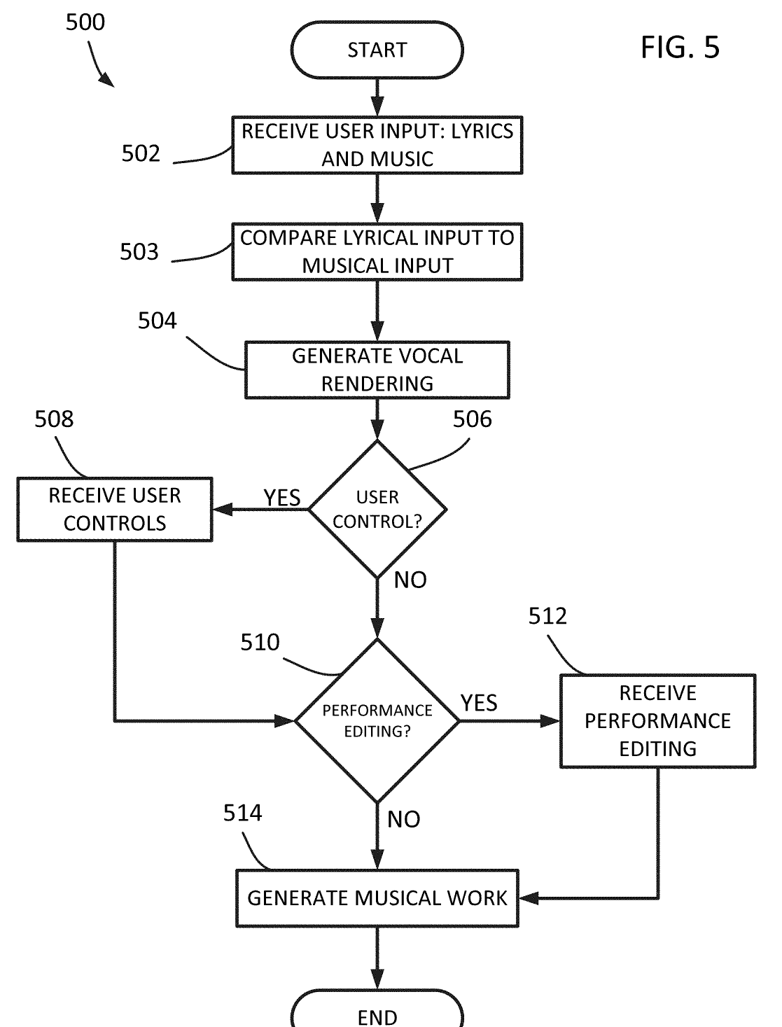

One overview of a method 500 of operating the system is shown in FIG. 5. At 502, the system 100 may receive user input of text and melody. In some embodiments, the text may be a lyrical input of the lyrics the musical work the user seeks to create, and the melody may be a musical input from various sources as described in further detail herein. At 503, at least one characteristic of the lyrical input may be compared to the musical input. For example, the number of syllables of the lyrical input may be compared to the number of notes in the musical input, or any other of the various analyses described herein with respect to method 200. In some embodiments, the comparison of the at least one characteristic of the lyrical input and the at least one characteristic of the musical entity may be compared to determine at least one disparity between the lyrical input and the musical input. At 504, a vocal rendering of the lyrical input may be generated based at least upon the characteristics of the lyrical input and the musical input such as described with relation to the method 200. In some embodiments, however, the vocal rendering may be based merely upon the lyrical input alone. For example, the vocal rendering may analyze the lyrics included in the lyrical input and break down words, phrases, syllables, or phonemes for identification. At 506, the system may determine whether user controls, either automatically or by a user. In some embodiments, user controls may include pre-authored lyrics, associated vocal performances (i.e., “licks”), pre-defined stylistic settings, vocal effects, etc. In some embodiments, additional pre-authored lyrics that may differ from or be in addition to the lyrical input may also be rendered and automatically assigned to the melody of the musical input. In some embodiments, the “licks” may include different melodies that may be harmonious to the melody of the musical input. User controls for stylistic settings may be include vocal idiosyncrasies that determine the genre of the music, the emotion of the lyrics, etc. These idiosyncrasies may be captured by the system and available to the user to apply to a musical work, or may be applied automatically based on a user's selection of a singer with particular voice characteristics. A user may also include (or may be automatically applied) vocal effects such as reverb, delay, stutter effects, pitch shift, etc. If a user has opted to implement any of these user controls or have been implemented automatically, at 506, the method 500 may include receiving those controls and including them into the musical work at 508. After the user controls have been received at 508, or if no user controls are included at 506, the system may determine whether performance editing at 510 is to be included, either automatically or via user input. In some embodiments, performance editing may include MIDI roll editing, tactile control, vocal effects adjustment, text-to-melody augmentation, etc. Once any performance editing has been chosen by the user, the performance editing may be received by the system at 512. At 514, the system may incorporate any and all user controls effects or performance editing effects to generate the final musical work to be output, stored, or sent in a message. It is contemplated that, in some embodiments, the performance editing may take place simultaneous with or prior to the user controls. Each of the listed performance editing features are described in further detail below, and description of the types of effects is described in further detail with respect to method 200 herein. It is also contemplated that either or both of the user controls effects or the performance editing effects may be received by the system before or after sending formatted data to a voice synthesizer for generation of a vocal rendering. In some embodiments, the system may re-correlated the lyrical input and the musical input after receiving additional user controls or performance editing so that a new vocal rendering may be generated taking into account the additional received effects edits.

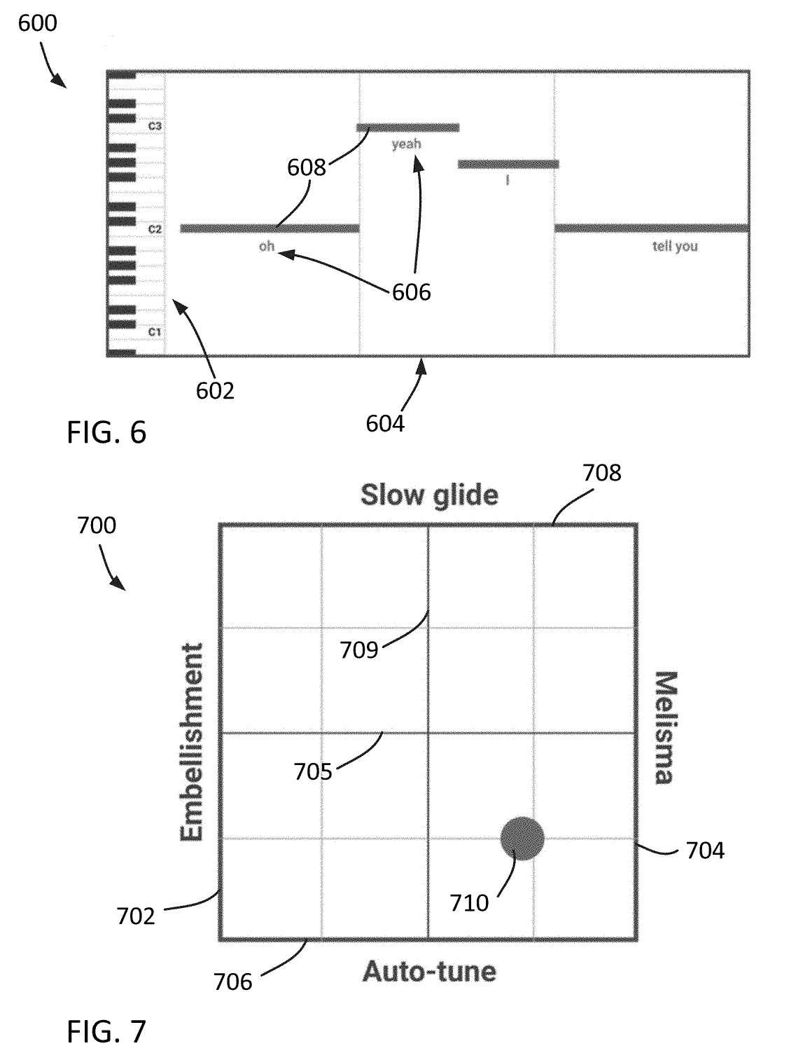

MIDI roll editing may include adjusting the timing of each musical note within a melody by, for example, clicking on a visual depiction of the musical input or musical work on a user interface, and dragging the length of that note the lengthen or shorten its timing. An exemplary graphical user interface (GUI) 600 for MIDI rolling is shown in FIG. 6. The MIDI rolling GUI may include an note indication 602 on one axis, and a time indication 604 on another axis. In the illustrated embodiment, the note indication 602 is represented by a graphical depiction of a piano keyboard, with the note “C” shown in several octaves. It should be understood that other graphical representations may be used. The lyrics or words from the lyrical input may be indicated as lyric indications 606. The lyric indications 606 may be accompanied by note bars 608 that may indicate the note at which the corresponding lyric is sung or played with respect to the vertical axis 602. The length of the note bars 608 with respect to the horizontal (i.e., time) axis 604 may also indicate for how long that particular lyric or group of lyrics may be played at the specified note. In some embodiments, the length of the note bar 608 may be adjusted by lengthening or shortening the note bar, and the note of the lyrics may be adjusted by moving the note bar with respect to the vertical (i.e., note) axis.

Tactile control may provide a user with the ability to change the way that a sung melody in a musical work is performed. FIG. 7 shows an example of a graphical user interface (GUI) 700 that the system may provide a user to adjust tactile control, such as embellishment, auto-tune, melisma, and slow glide. Some of these effects and the adjustment thereof is described in further detail above with respect to method 200. The tactile control GUI 700 may include several control aspects that may act in opposition to one another, and provide an effects indicator 710 to make adjustments among those controls and effects. For example, in GUI 700, embellishment limit 702 may represent the maximum embellishment available, and the melisma limit 704 may represent the maximum melisma available as an effect. The portions of the GUI 700 between the embellishment limit 702 and the melisma limit 704 may represent a sliding scale of positions along an embellishment-melisma slider 705 between the maximums of either effect. When the effects indicator 710 may be moved towards the melisma limit 704, the more individual syllables may be performed or played over consecutive musical notes in the musical input. In some embodiments, when the effects indicator 710 may be moved toward the embellishment limit 702, additional notes may be added to the melody. In some embodiments, if there are more embellished melodic notes than are syllables in the lyrical input lyrics, lyrical repetition may be utilized. Similarly, the auto-tune limit 706 may represent the maximum auto-tune effect available, and the slow glide limit 708 may represent the maximum slow glide effect available. The portions of the GUI 700 between the auto-tune limit 706 and the slow glide limit 708 may represent a sliding scale of positions along an autotune-slow glide slider 709 between the maximums of either effect. In some embodiments, movement of the effects indicator 710 along the autotune-slow glide slider 709 may control how quickly a note “snaps” from one note to the next. If the effects indicator 710 is moved toward the slow glide limit 708, the vocal performance in the musical work may sound looser and take a longer time to move from one note to the next in a melody. Conversely, if the effects indicator 710 is moved toward the auto-tune limit 706, the vocal performance of the lyrics may sound tighter and take less time to move from one note to the next. Thus, in some embodiments, the GUI 700 may provide a multidimensional tool for a user to make various adjustments to musical effects. It is contemplated that, in some embodiments, additional effects may be displayed in the GUI to provide additional control.

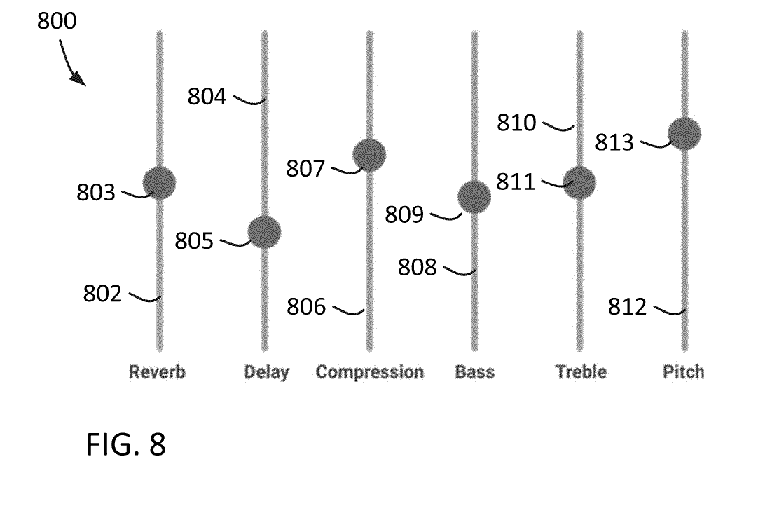

Vocal effects adjustment may allow a user to adjust the sound of the sung vocal performance in the musical work. FIG. 8 shows an example vocal effects GUI 800 for adjusting certain effects. For example, a reverb effects indicator 803 may slide along a reverb scale 802 to increase or decrease reverb effect, a delay effects indicator 805 may slide along a delay scale 804 to increase or decrease delay effect, a compression effects indicator 807 may slide along a compression scale 806 to increase or decrease compression effects, a bass effect indicator 809 may slide along a bass scale 808 to increase or decrease bass, a treble effect indicator 811 may slide along a treble scale 810 to increase or decrease treble, and a pitch effect indicator 813 may slide along a pitch scale 812 to increase or decrease pitch. It should be understood that fewer or additional effects may be included in the vocal effects GUI 800. In some embodiments, controlling each effect may control the sound in the synthesized musical work.

Text-to-melody augmentation may be used to automatically adjust, for example, the way the lyrics provide in the input text may be sung over the musical input. Traditionally, popular music may be recognizable or memorable due at least in part to repeated short musical phrases, or leitmotifs, that may match in both a lyrical or musical note structure. Often times the rhythm and phrase signatures for lyrics and music may match. Traditionally, finding the best relationship between leitmotifs and lyrics may be difficult without the help of an expert singer with experience in lyrical phrasing. The system herein, however, may provide an algorithmically driven combinatory approach to discerning leitmotifs and poetic cadence to enhance a user's ability to best match lyrics and music.

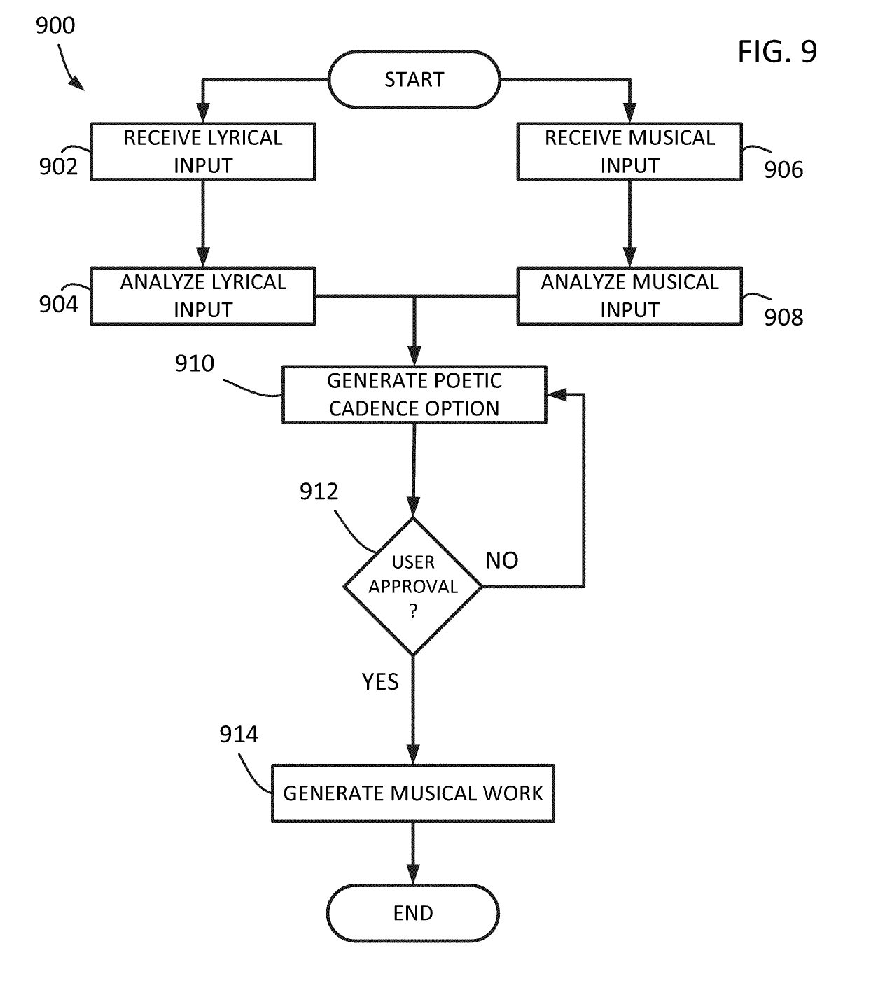

An example of an embodiment of such an approach is illustrated in the method 900 of FIG. 9 and executable by the system 100. At 902, the system may receive a lyrical input of the lyrics to be used in a musical work and, at 906, receive a musical input that the lyrics may be sung over in the musical work. As described above, the musical input may be MIDI notes input by the user via a MIDI device, or may be generated from an analog recording and analyzed to detect pitch, tempo, and other properties. At 904, the lyrical input may be analyzed to understand the lyrics. In some embodiments, this analysis may include natural language processing, natural language understanding, and other analyses such as those described herein with respect to method 200. At 908, the system may analyze the musical input, such as by using leitmotif detection. In some embodiments, the leitmotif detection process may include reference to a leitmotif dataset, which may include numerous examples of leitmotifs used in other music from which to reference. At 910, the method 900 may include generating poetic cadence options that may be presented to the user based on the analysis of the lyrical input and the musical input. In some embodiments, at 912, the user may approve of the generated poetic cadence option or not. If the user does not approve, an alternative poetic cadence may be generated. If the user approves the generated poetic cadence option the user may indicate that approval and, at 914, the poetic cadence option will be used to generated the musical work. It should be understood that method 900 may be implemented in addition to or in concurrence with the other effects control measures described herein, such as method 200.

It will be understood by those skilled in the art that, in certain embodiments, the media generation system can use any of the individual solutions alone while correlating the musical input with the lyrical input, or can implement various solutions described herein sequentially or simultaneously to optimize the output quality of a musical message. For example, the system may use embellishment to lengthen a musical input so that it becomes half the length of the lyrical input, followed by using repetition of the embellished musical input to more closely match up with the lyrical input. Other combinations of solutions are also contemplated herein to accomplish the task of correlating the musical input with the lyrical input so that the finalized musical message is optimized. It is also contemplated that other techniques consistent with this disclosure could be implemented to effectively correlate the musical input with the lyrical input in transforming the lyrical input and musical input into a finalized musical message.

One skilled in the art would understand that the media generation system and the method for operating such media generation system described herein may be performed on a single client device, such as client device 104 or server 108, or may be performed on a variety of devices, each device including different portions of the system and performing different portions of the method. For example, in some embodiments, the client device 104 or server 108 may perform most of the steps, but the voice synthesis may be performed by another device or another server. The following includes a description of one embodiment of a single device that could be configured to include the media generation system described herein, but it should be understood that the single device could alternatively be multiple devices.

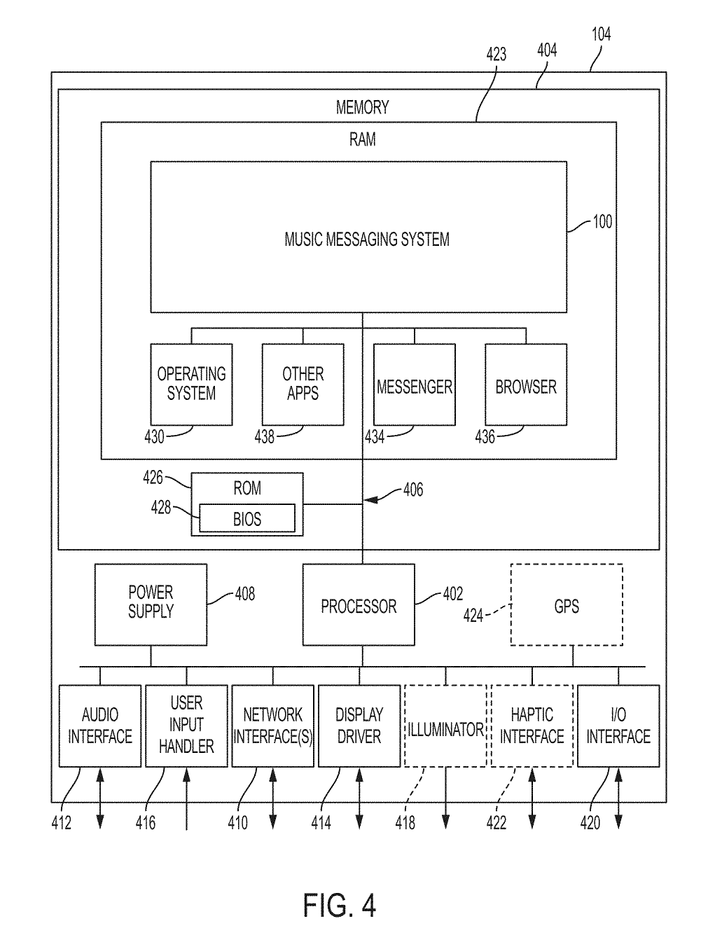

FIG. 4 shows one embodiment of the system 100 that may be deployed on any of a variety of devices 101-105 or 108 from FIG. 1, or on a plurality of devices working together, which may be, for illustrative purposes, any multi-purpose computer (101, 102), hand-held computing device (103-105) and/or server (108). For the purposes of illustration, FIG. 4 depicts the system 100 operating on device 104 from FIG. 1., but one skilled in the art would understand that the system 100 may be deployed either as an application installed on a single device or, alternatively, on a plurality of devices that each perform a portion of the system's operation. Alternatively, the system may be operated within an http browser environment, which may optionally utilize web-plug in technology to expand the functionality of the browser to enable functionality associated with system 100. Device 104 may include many more or less components than those shown in FIG. 4. However, it should be understood by those of ordinary skill in the art that certain components are not necessary to operate system 100, while others, such as processor, video display, and audio speaker are important to practice aspects of the present invention.

As shown in FIG. 4, device 104 includes a processor 402, which may be a CPU, in communication with a mass memory 404 via a bus 406. As would be understood by those of ordinary skill in the art having the present specification, drawings and claims before them, processor 402 could also comprise one or more general processors, digital signal processors, other specialized processors and/or ASICs, alone or in combination with one another. Device 104 also includes a power supply 408, one or more network interfaces 410, an audio interface 412, a display driver 414, a user input handler 416, an illuminator 418, an input/output interface 420, an optional haptic interface 422, and an optional global positioning systems (GPS) receiver 424. Device 104 may also include a camera, enabling video to be acquired and/or associated with a particular musical message. Video from the camera, or other source, may also further be provided to an online social network and/or an online music community. Device 104 may also optionally communicate with a base station or server 108 from FIG. 1, or directly with another computing device. Other computing device, such as the base station or server 108 from FIG. 1, may include additional audio-related components, such as a professional audio processor, generator, amplifier, speaker, XLR connectors and/or power supply.

Continuing with FIG. 4, power supply 408 may comprise a rechargeable or non-rechargeable battery or may be provided by an external power source, such as an AC adapter or a powered docking cradle that could also supplement and/or recharge the battery. Network interface 410 includes circuitry for coupling device 104 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Accordingly, network interface 410 may include as a transceiver, transceiving device, or network interface card (NIC).

Audio interface 412 (FIG. 4) is arranged to produce and receive audio signals such as the sound of a human voice. Display driver 414 (FIG. 4) is arranged to produce video signals to drive various types of displays. For example, display driver 414 may drive a video monitor display, which may be a liquid crystal, gas plasma, or light emitting diode (LED) based-display, or any other type of display that may be used with a computing device. Display driver 414 may alternatively drive a hand-held, touch sensitive screen, which would also be arranged to receive input from an object such as a stylus or a digit from a human hand via user input handler 416.

Device 104 also comprises input/output interface 420 for communicating with external devices, such as a headset, a speaker, or other input or output devices. Input/output interface 420 may utilize one or more communication technologies, such as USB, infrared, Bluetooth™, or the like. The optional haptic interface 422 is arranged to provide tactile feedback to a user of device 104. For example, in an embodiment, such as that shown in FIG. 1, where the device 104 is a mobile or handheld device, the optional haptic interface 422 may be employed to vibrate the device in a particular way such as, for example, when another user of a computing device is calling.

Optional GPS transceiver 424 may determine the physical coordinates of device 104 on the surface of the Earth, which typically outputs a location as latitude and longitude values. GPS transceiver 424 can also employ other geo-positioning mechanisms, including, but not limited to, triangulation, assisted GPS (AGPS), E-OTD, CI, SAI, ETA, BSS or the like, to further determine the physical location of device 104 on the surface of the Earth. In one embodiment, however, the mobile device may, through other components, provide other information that may be employed to determine a physical location of the device, including for example, a MAC address, IP address, or the like.

As shown in FIG. 4, mass memory 404 includes a RAM 423, a ROM 426, and other storage means. Mass memory 404 illustrates an example of computer readable storage media for storage of information such as computer readable instructions, data structures, program modules, or other data. Mass memory 404 stores a basic input/output system (“BIOS”) 428 for controlling low-level operation of device 104. The mass memory also stores an operating system 430 for controlling the operation of device 104. It will be appreciated that this component may include a general purpose operating system such as a version of MAC OS, WINDOWS, UNIX, LINUX, or a specialized operating system such as, for example, Xbox 360 system software, Wii IOS, Windows Mobile™, iOS, Android, webOS, QNX, or the Symbian® operating systems. The operating system may include, or interface with, a Java virtual machine module that enables control of hardware components and/or operating system operations via Java application programs. The operating system may also include a secure virtual container, also generally referred to as a “sandbox,” that enables secure execution of applications, for example, Flash and Unity.

One or more data storage modules may be stored in memory 404 of device 104. As would be understood by those of ordinary skill in the art having the present specification, drawings, and claims before them, a portion of the information stored in data storage modules may also be stored on a disk drive or other storage medium associated with device 104. These data storage modules may store multiple track recordings, MIDI files, WAV files, samples of audio data, and a variety of other data and/or data formats or input melody data in any of the formats discussed above. Data storage modules may also store information that describes various capabilities of system 100, which may be sent to other devices, for instance as part of a header during a communication, upon request or in response to certain events, or the like. Moreover, data storage modules may also be employed to store social networking information including address books, buddy lists, aliases, user profile information, or the like.

Device 104 may store and selectively execute a number of different applications, including applications for use in accordance with system 100. For example, application for use in accordance with system 100 may include Audio Converter Module, Recording Session Live Looping (RSLL) Module, Multiple Take Auto-Compositor (MTAC) Module, Harmonizer Module, Track Sharer Module, Sound Searcher Module, Genre Matcher Module, and Chord Matcher Module. The functions of these applications are described in more detail in U.S. Pat. No. 8,779,268, which has been incorporated by reference above.

The applications on device 104 may also include a messenger 434 and browser 436. Messenger 434 may be configured to initiate and manage a messaging session using any of a variety of messaging communications including, but not limited to email, Short Message Service (SMS), Instant Message (IM), Multimedia Message Service (MMS), internet relay chat (IRC), mIRC, RSS feeds, and/or the like. For example, in one embodiment, messenger 434 may be configured as an IM messaging application, such as AOL Instant Messenger, Yahoo! Messenger, .NET Messenger Server, ICQ, or the like. In another embodiment, messenger 434 may be a client application that is configured to integrate and employ a variety of messaging protocols. In one embodiment, messenger 434 may interact with browser 436 for managing messages. Browser 436 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages, including Python, Java, and third party web plug-ins, may be employed.

Device 104 may also include other applications 438, such as computer executable instructions which, when executed by client device 104, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VoIP applications, contact managers, task managers, transcoders, database programs, word processing programs, security applications, spreadsheet programs, games, search programs, and so forth. Each of the applications described above may be embedded or, alternately, downloaded and executed on device 104.

Of course, while the various applications discussed above are shown as being implemented on device 104, in alternate embodiments, one or more portions of each of these applications may be implemented on one or more remote devices or servers, wherein inputs and outputs of each portion are passed between device 104 and the one or more remote devices or servers over one or more networks. Alternately, one or more of the applications may be packaged for execution on, or downloaded from a peripheral device.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A computer implemented method for automatically generating musical works, the computer implemented method comprising:
receiving a lyrical input;
receiving a musical input;
analyzing, via one or more processors, the lyrical input to determine at least one lyrical characteristic;
analyzing, via the one or more processors, the musical input to determine at least one musical characteristic;
based on the at least one lyrical characteristic, correlating, via the one or more processors, the lyrical input with the musical input to generate a synthesizer input;
sending the synthesizer input to a voice synthesizer;
receiving, from the voice synthesizer, a vocal rendering of the lyrical input;
receiving a singer selection corresponding to at least one voice characteristic; and
generating a musical work from the vocal rendering based on the lyrical input, the musical input, and the at least one voice characteristic.

2. The method of claim 1, further comprising receiving inputs for at least one performance editing effect via a graphical user interface.

3. The method of claim 2, wherein the performance editing effect is a melisma effect.

4. The method of claim 1, wherein correlating the lyrical input with the musical input includes comparing, via the one or more processors, the at least one lyrical characteristic to the at least one musical characteristic.

5. The method of claim 1, wherein the at least one lyrical characteristic is a syllable count and the at least one musical characteristic is a note count.

6. The method of claim 5, wherein correlating the lyrical input with the musical input includes comparing the syllable count of the lyrical input to the note count of the musical input to determine a note differential.

7. The method of claim 6, wherein correlating the lyrical input with the musical input further comprises generating the synthesizer input at least partially based on the note differential.

8. The method of claim 1, further comprising receiving an input adjusting a timing of a note of the musical work via graphical user interface.

9. A computer implemented method for automatically generating musical works, the computer implemented method comprising:
receiving a lyrical input;
receiving a musical input;
analyzing, via one or more processors, the lyrical input to determine a lyrical characteristic;
analyzing, via the one or more processors, the musical input to determine a musical characteristic;
comparing, via one or more processors, the lyrical characteristic with the musical characteristic to determine a disparity;
based on the determined disparity, automatically applying, via the one or more processors, at least one editing tool to the lyrical input to generate an altered lyrical input with an altered lyrical characteristic;
based on the altered lyrical characteristic, correlating, via the one or more processors, the altered lyrical input with the musical input to generate a synthesizer input;
sending the synthesizer input to a voice synthesizer;
receiving, from the voice synthesizer, a vocal rendering of the altered lyrical input; and
generating a musical work from the vocal rendering and the musical input.

10. The method of claim 9, further comprising, based on the determined disparity, automatically applying, via the one or more processors, at least one editing tool to the musical input to generate an altered musical input with an altered musical characteristic.

11. The method of claim 10, further comprising, correlating, via the one or more processors, the altered lyrical input with the altered musical input to generate the synthesizer input.

12. The method of claim 11, further comprising generating the musical work from the vocal rendering and the altered musical input.

13. The method of claim 9, further comprising receiving inputs for at least one performance editing effect via a graphical user interface.

14. The method of claim 13, wherein the performance editing effect is a melisma effect.

15. The method of claim 9, wherein the at least one editing tool is lyrical repetition.

16. The method of claim 9, wherein the lyrical characteristic is an original syllable count, the musical characteristic is a note count, and the altered lyrical characteristic is an altered syllable count different than the original syllable count.

17. A computer implemented method for automatically generating musical works, the computer implemented method comprising:
receiving a lyrical input;
receiving a musical input;
analyzing, via one or more processors, the lyrical input to determine a lyrical characteristic;
analyzing, via the one or more processors, the musical input to determine a musical characteristic;
comparing, via one or more processors, the lyrical characteristic with the musical characteristic to determine a disparity;
based on the determined disparity, automatically applying, via the one or more processors, at least one editing tool to the musical input to generate an altered musical input with an altered musical characteristic;
based on the lyrical characteristic, correlating, via the one or more processors, the lyrical input with the altered musical input to generate a synthesizer input;
sending the synthesizer input to a voice synthesizer;
receiving, from the voice synthesizer, a vocal rendering of the lyrical input; and
generating a musical work from the vocal rendering and the altered musical input.

18. The method of claim 17, wherein the editing tool is a melisma effect.

19. The method of claim 17, wherein the lyrical characteristic is a syllable count, the musical characteristic is an original note count, and the altered musical characteristic is an altered note count different than the original note count.

20. The method of claim 17, wherein determining the disparity includes comparing a note count of the musical input and a syllable count of the lyrical input.
